(19) United States
(12) Patent Application Publication
(10) Pub. No.: US 2011/0141136 A1
(43) Pub. Date: Jun. 16, 2011

(54) METHOD AND SYSTEM OF GRAPHICALLY REPRESENTING DISCRETE DATA AS A CONTINUOUS SURFACE

(75) Inventors: Andrew John Cardno, San Diego, CA (US); Peter Stewart Ingham, Lower Hutt (NZ); Bart Andrew Lewin, Woodland Hills, CA (US); Ashok Kumar Singh, Henderson, NV (US)

(73) Assignee: Business Intelligence Solutions Safe B.V., Amsterdam (NL)

(21) Appl. No.: 12/866,838

(22) PCT Filed: Jun. 19, 2009
(86) PCT No.: PCT/NZ09/00112

§ 371 Date: Mar. 3, 2011

Related U.S. Application Data
(60) Provisional application No. 61/074,347, filed on Jun. 20, 2008.
(60) Provisional application No. 61/101,672, filed on Sep. 30, 2008.

(51) Int. Cl. G09G 5/00

(52) U.S. Cl. 345/606

(57) ABSTRACT

In a data visualization system, a method of graphically representing discrete data as a continuous surface in image space, the method comprising the steps of: a data retrieval module retrieving discrete data from a data storage device in communication with the data visualization system; an interpolation module calculating a first set of values for a weighted interpolation function based on the retrieved discrete data; a smoothing module calculating a second set of values for one or more weighted approximation functions based on the retrieved discrete data; and a surface combining module combining the first and second set of calculated values over the image space to graphically represent a continuous surface.

### FIELD OF THE INVENTION

The present invention relates to a method and system of graphically representing discrete data as a continuous surface.

### BACKGROUND

A chart or graph is described in Wikipedia as a type of information graphic or graphic organizer that represents tabular numeric data and/or functions. Charts are often used to make it easier for humans to understand large quantities of data and the relationship between different parts of the data. Charts can usually be understood by a human reader more quickly than the raw data that they come from. They are used in a wide variety of fields, and can be created by hand (often on graph paper) or by computer using a charting application.

Traditional charts use well established but often poorly implemented ways of representing data. Many tools exist to help the user construct very sophisticated representations of data but that sophistication typically results in less meaningful charts. Embodiments of the present invention aim to overcome this problem.

It is known to use charting wizards such as those that are available in Excel and various other systems such as those provided by, for example, IBM. In addition there are multiple Business Intelligence (BI) tools available to users to enable users to analyze data in an attempt to create meaningful feedback. However, as the amount of data increases, so does the complexity of the visual representations created by the analysis of the data. These complex representations can end up swamping parts of the visual representation that is most required and relevant to an end user.

Further, the focus of existing known methods of graphically representing data is on providing a single visual design, or type of visual or graphical representation, to represent data. That is, to produce, for example, a single bar graph to be displayed, or a single pie chart to be printed. This is very limiting to a user who may want to show various different aspects of the data in a single document.

When representing discrete data points in a graphical representation, a whole new set of problems should be considered by a person developing a graphical visualization system that is arranged to produce graphical representations of the discrete data.

In particular, when developing a system that creates a continuous surface to represent the discrete data, the design of the system should be such that relevant data points can be easily discerned from the graphical representation, and that data point values are accurately represented along with an accurate representation of the calculated values in-between the discrete data points. A further problem that should be addressed by the system designer is how to stop smaller value data points being swamped by larger value data points resulting in a loss of data being represented to the user. Known systems do not at present allow both the overall picture and details of the data to be graphically represented on the same continuous surface at the same time.

According to traditional known methods of calculating a contiguous or continuous surface, a formula, such as a gravity model, is applied to the data being graphically represented. These gravity models create visual displays of data that enable much higher density of information to be shown. However, merely using a single gravity model may create visual artefacts, visual anomalies or distortions in the display of data. Therefore, the surface will not provide the user with a visualization that accurately shows the overall effect of the data being visualized. Further, the surface will not provide accurate local minima and maxima. The simplest form of the gravity model is sometimes called ‘Shepards Method’ or Inverse Distance Weighting (IDW) Method of spatial interpolation (Isaaks and Srivastava, 1989).

The present invention aims to overcome, or at least alleviate, some or all of the mentioned problems, or to at least provide the public with a useful choice.

### SUMMARY OF THE INVENTION

Various concepts are herein disclosed as set out in the claims at the end of the specification.

Systems and methods are described herein that allow for different densities of data to be displayed on a contiguous or continuous surface without the points of data that are being graphically represented close together creating overlapping effects, as these effects may obscure the results as represented by other data points. Further, systems and methods are described herein that allow different densities of data to be displayed on a contiguous or continuous surface such that overall or general information associated with the data is conveyed alongside specific detailed data related to specific data points.

### BRIEF DESCRIPTION OF THE DRAWINGS

Embodiments of the present invention will now be described, by way of example only, with reference to the accompanying drawings, in which:

FIG. 1A shows a NASDAQ Heat Map Example;

FIG. 1B shows a NASDAQ Heat Map Intra Day Data Example;

FIG. 1C shows a diagrammatical representation of some key terms;

FIG. 2A shows a system concept diagram according to an embodiment of the present invention;

FIG. 2B shows an overview of the software modules in the described system.

FIG. 3 shows a general overview of the data flow within the system according to an embodiment of the present invention;

FIG. 4 shows an architectural overview of the described solution according to an embodiment of the present invention;

FIG. 5 shows a high-level system delivery overview of the described solution according to an embodiment of the present invention;

FIG. 6A shows a general data flow diagram according to an embodiment of the present invention;

FIG. 6B shows a flow diagram according to an embodiment of the present invention;

FIG. 7 shows the concept of layers according to an embodiment of the present invention;

FIG. 8 shows a conceptual system diagram according to one embodiment of the present invention;

FIG. 9 shows a conceptual system diagram according to a further embodiment of the present invention;

FIGS. 10A to 10D show various stages when creating the surfaces according to various embodiments of the present invention;

FIGS. 11A to L show various diagrams relating to creating a composite surface visualization according to various embodiments of the present invention;

FIG. 12 shows how embodiments of the present invention may be incorporated within a gaming environment;

### DETAILED DESCRIPTION OF THE INVENTION

The following described invention is suitable for use in conjunction with other methods, and the incorporation into one or more systems, for example as described in METHODS, APPARATUS AND SYSTEMS FOR DATA VISUALISATION AND RELATED APPLICATIONS (earlier filed by the applicant in the entirety as U.S. provisional patent application Ser. No. 61/074,347 filed on 20 Jun. 2008), which is incorporated by reference, and a portion of which herein follows.

Four key terms (or concepts) form the foundation of the specification set out in this document and accordingly have been defined as follows:

The four key terms are:

### Business Performance Drivers (BPD)

### BPD Packages

### Visual Designs

### Visual Documents

The key terms are defined as follows:

Business Performance Drivers (BPDs): A Business Performance Driver (BPD) is a business metric used to quantify a business objective. For example, turnover, sales. BPDs are Facts (sometimes referred to as measures). Facts are data items that can be counted. For example, Gross Sales; Units Sold. BPDs comprise of:
1. Measures: Data items that can be counted. For example, Gross Sales; Units Sold.
2. Dimensions: Data items that can be categorized. For example, Gender; Locations.
3. Restrictions can be applied to BPDs. These filter the data included. For example a restriction of ‘State=“CA”’ may be specified to only include data for California.
4. Normalizations can be applied to BPDs. These specify (or alter) the time period the BPD refers to. For example—Daily Units Sold, Monthly Profit.
The combination of BPDs, Restrictions and Normalizations provides the flexibility to create many ways of looking at data without requiring extensive definition effort.

In other words a Business Performance Driver (BPD) is a ‘measure’ that can be normalized. Measures are data items that can be counted. For example, Gross Sales; Units Sold. BPDs might be displayed on visualizations. For example, Revenue earned per store on a map. Restrictions and/or Normalizations could be applied to a BPD. The following table provides examples of these:

| Scenario | Business Example |
|---|---|
| BPD (no | Revenue |
| normalization | |
| or restriction) | |
| BPD with | Revenue earned in the state of California |
| restriction | |
| BPD with | Revenue earned in week 1 of 2008 |
| normalization | |
| BPD with | Revenue earned in the state of California in week 1 of |
| restriction and | 2008 |
| normalization | |

BPD Packages: A BPD Package is made up from a set of related BPDs. This relationship (between a BPD Package and its BPDs) is defined using metadata. BPD Packages can be thought of as the Visual Document's vocabulary.

Visual Designs: Visual Designs are a classification of the different types of visualizations that a user may choose. Within each Visual Design, there are a number of visualizations. For example, the ‘spatial’ category can have retail store location maps or geographical location maps. The software solution allows users to select one visualization (one visual form within a Visual Design category) to create a Visual Document.

Visual Document: A Visual Document contains visual representations of data. Access to the data used to construct the visual representation is in many ways analogous to a textual document. A Visual Document is constructed by applying BPD data to a specific Visual Design. It is designed to illustrate at least one specific point (using the visualization), supports the points made with empirical evidence, and may be extended to provide recommendations based on the points made. The Visual Document is a deliverable to the user.

| Dimensions | Dimensions are data items that can be categorized. For | | | |
|---|---|---|---|---|
| | example, Gender; Locations. | | | |
| | Dimensions might be displayed on visualizations. For | | | |
| | example product categories on a shop floor. | | | |
| Fact | See Business Performance Drivers (BPDs) | | | |
| Measure | See Business Performance Drivers (BPDs) | | | |
| Normalizations | Can be applied to BPDs. These specify (or alter) the | | | |
| | time period the BPD refers to. For example - Daily | | | |
| | Units Sold, Monthly Profit. | | | |
| | The combination of BPDs, Restrictions and | | | |
| | Normalizations provides the flexibility to create many | | | |
| | ways of looking at data without requiring extensive | | | |
| | definition effort. Refer to definition of BPDs for | | | |
| | examples. | | | |
| Restrictions | Can be applied to BPDs or Dimensions. These filter the | | | |
| | data included. For example a restriction of ‘State = | | | |
| | “CA”’ may be specified to only include data for | | | |
| | California. | | | |
| | A BPD or Dimension could be restricted by Compound | | | |
| | Statements (series of restrictions using AND/OR | | | |
| | statements). For example, Revenue from all stores | | | |
| | where state = California AND units sold >200 units. | | | |
| | Restrictions have the following types: | | | |
| | Restriction | | | Business |
| | Type | Definition | Example | Context |
| | = | Equal to | State = | Revenue |
| | | | ‘CA’ | earned |
| | | | | within the |
| | | | | state of |
| | | | | California |
| | >= | Greater | Units | Revenue |
| | | than or | Sold >= | earned from |
| | | equal to | 200 | stores where |
| | | | | units sold |
| | | | | were greater |
| | | | | than (or |
| | | | | equal to) 200 |
| | | | | units |
| | =< | Less than | Revenue =< | Revenue |
| | | or equal to | $50,000 | earned from |
| | | | | stores where |
| | | | | Revenue was |
| | | | | less than (or |
| | | | | equal to) |
| | | | | $50,000 |
| | > | Greater | Units | Revenue |
| | | than | Sold | earned from |
| | | | >200 | stores where |
| | | | | the number |
| | | | | of units sold |
| | | | | were greater |
| | | | | than |
| | | | | 200units |
| | < | Less than | Units | Revenue |
| | | | Sold | earned from |
| | | | <200 | stores where |
| | | | | the number |
| | | | | of units sold |
| | | | | were less |
| | | | | than |
| | | | | 200units |
| | IN | In (list) | State IN | Revenue |
| | | | (‘CA’, | earned from |
| | | | ‘NY’) | stores within |
| | | | | the states of |
| | | | | California |
| | | | | and New |
| | | | | York |
| | BETWEEN | Values | Product | Revenue |
| | | between X | Code | earned from |
| | | and Y | between | product |
| | | | ‘124’ and | codes 124 to |
| | | | ‘256’ | 256 |
| | | | | (inclusive) |
| | NOT = | Not Equal | State NOT = | Revenue |
| | | to | CA | earned from |
| | | | | stores |
| | | | | outside the |
| | | | | state of |
| | | | | California. |
| | NOT IN | Not in | State NOT | Revenue |
| | | (list) | IN (‘CA’, | earned from |
| | | | ‘NY’) | outside the |
| | | | | states of |
| | | | | California |
| | | | | and New |
| | | | | York. |
| | NOT | Values not | Store | Revenue |
| | BETWEEN | between X | Code | earned from |
| | | and Y | NOT | stores |
| | | | Between | excluding |
| | | | 105 and | stores with a |
| | | | 110 | store code |
| | | | | between 105 |
| | | | | and 110 |
| | | | | (inclusive). |

Heatmaps: A heat map is a graphical representation of data where the values taken by a variable in a two-dimensional map are represented as colors. A very similar presentation form is a Tree map.

Heat maps are typically used in Molecular Biology to represent the level of expression of many genes across a number of comparable samples (e.g. cells in different states, samples from different patients) as they are obtained from DNA microarrays.

Heat maps are also used in places where the data is volatile and representation of this data as a heat map improves usability. For example, NASDAQ uses heat maps to show the NASDAQ-100 index volatility. Source: Wikipediaⁱ

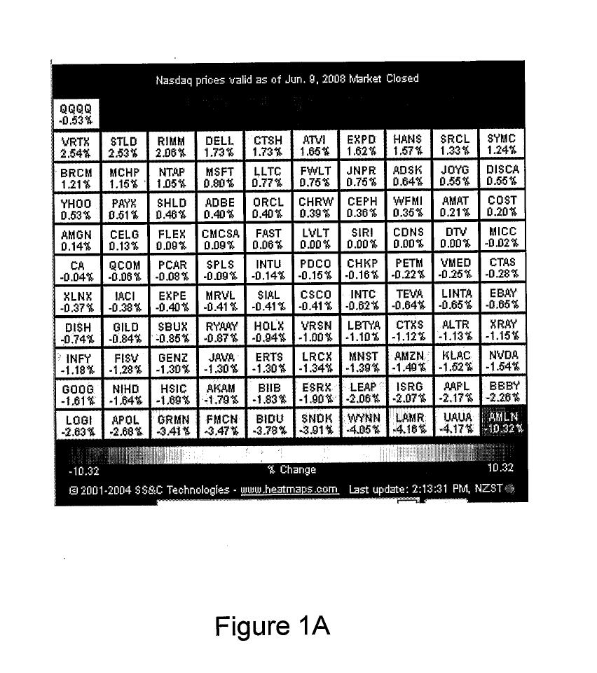

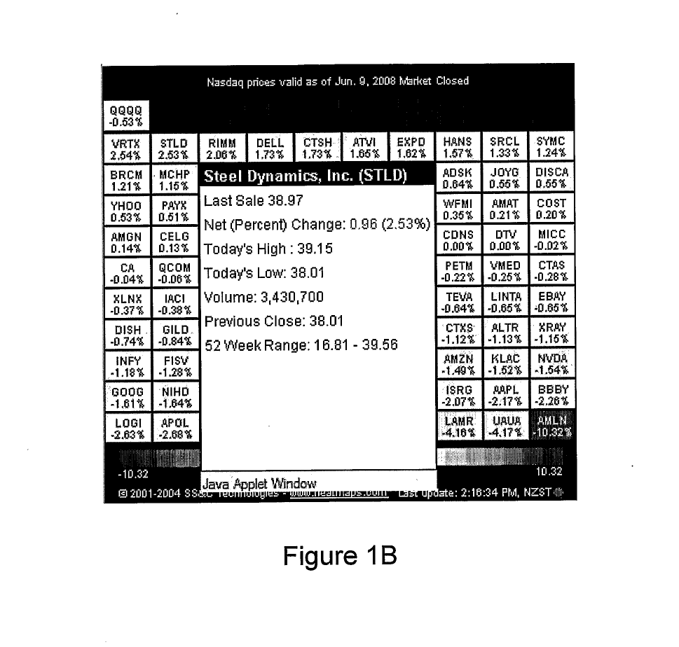

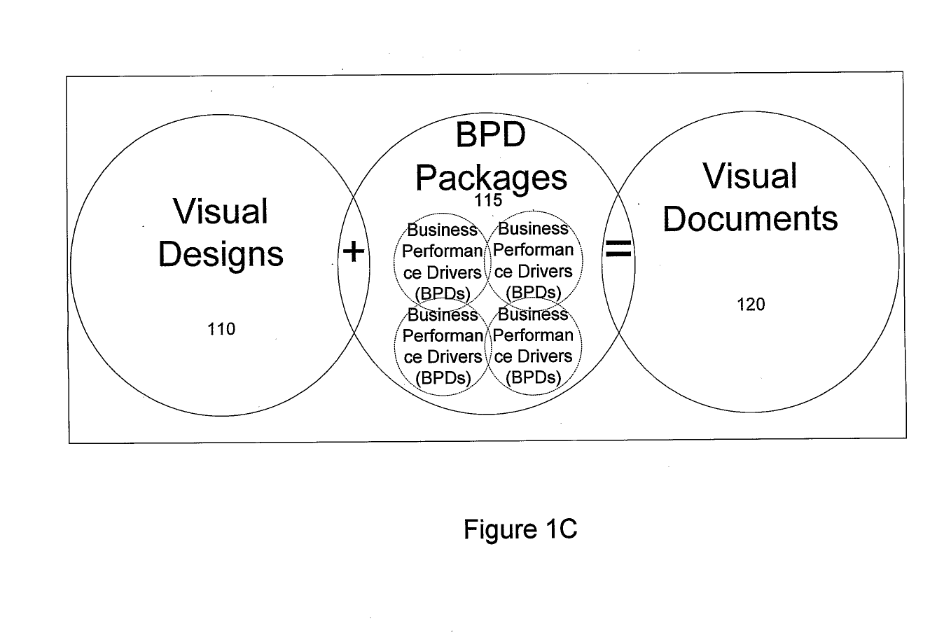

This is shown diagrammatically in FIG. 1A. Some blocks are colored green, which means the stock price is up and some blocks are colored red, which means the stock price is down. The blocks have a varying deepening of the relevant color to indicate the direction that the stock is moving. The deeper the color, the bigger the move.

If a user hovers over a stock, additional intra-day data is presented—as shown in FIG. 1B: Source: Nasdaq.comⁱⁱ

The key terms are set out diagrammatically in FIG. 1C. Visual designs 110 are individual visualization techniques. One or more are applied to visualize BPD packages 115 to create visual documents 120.

Many organizations are facing massive and increasing amounts of data to interpret, the need to make more complex decisions faster, and accordingly are turning to data visualization as a tool for transforming their data into a competitive advantage. This is particularly true for high-performance companies, but it also extends to any organization whose intellectual property exists in massive, growing data sets.

One objective of the described solution is to put experts' data visualization techniques in the customer's hands by skillfully guiding the end user through choosing the right parameters, to display the right data, and to create its most useful visualizations to improve business performance.

The described solution is a generic tool and can apply to multiple business areas that require decisions based on and understanding massive amounts of data. The resulting browser-based output is defined as a ‘Visual Document’.

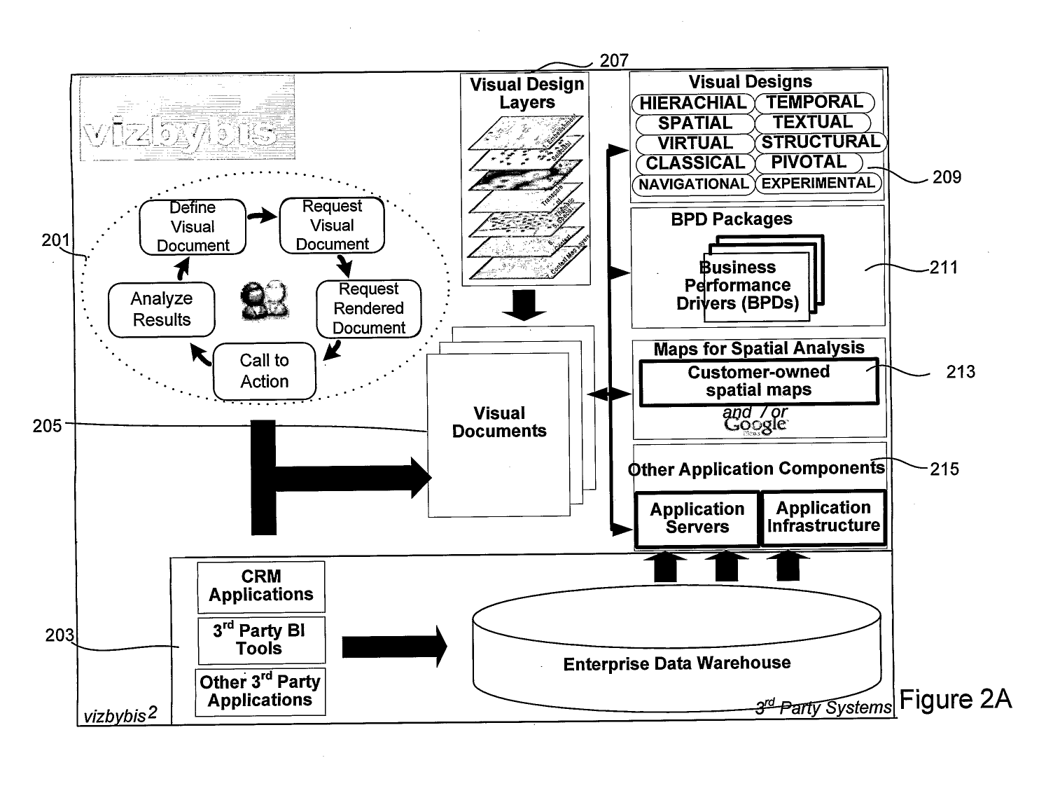

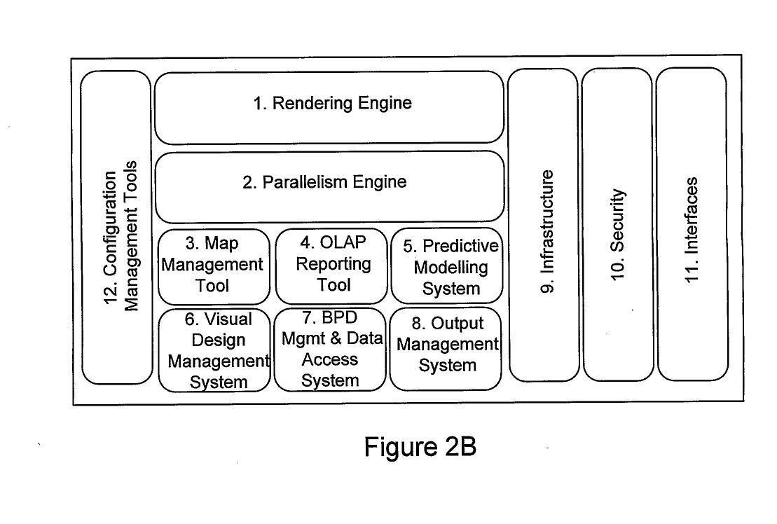

The solution provided is summarized in FIG. 2A.

The system identifies user tasks 201 in the form of defining visual documents, requesting visual documents, requesting rendered documents, calls to action, and analyzing results. These tasks are then detected by the system in conjunction with other systems 203, which include CRM applications, third party Business Intelligence (BI) Tools and other third party applications, all of which may access data stored in an enterprise data warehouse (EDW). The visual design layer concept 207 may be utilized within the visual documents 205. The creation of the visual documents is made in conjunction with a number of different defined visual design types 209, BPD packages 211, spatial analysis maps 213 and other application components 215, such as application servers and application infrastructure.

A Visual Document contains visual representations of data. Access to the data used to construct the visual representation is in many ways analogous to a textual document. It is constructed by applying Business Performance Driver(s) (BPD) data to a specific Visual Design (Visual Designs are grouped into ten classifications).

A Visual Document is designed to illustrate at least one specific point (using the visualization), support the points made with empirical evidence, and may be extended to provide recommendations based on the points made. The Visual Document is the actual deliverable from the software to the software user. Visual Documents may be stored, distributed or analyzed later, as needed.

The Visual Document is fed by data and a metadata database that stores definitions of BPDs—the BPDs are the focus of the Visual Document. A Business Performance Driver is a business metric used to quantify a business objective. Examples include, gross sales or units sold. For instance, the Visual Document may be used to graphically depict the relationship between several BPDs over time.

In the Visual Document, data is rendered in up to seven layers in one embodiment. However, it will be understood that the number of layers may be varied as needed by the user. Specific Visual Document Layers are described herein. However, it will be understood that further Visual Document Layers may be included over and above the specific types described.

Visual Designs are explicit techniques that facilitate analysis by quickly communicating sets of data (termed BPD Packages) related to BPDs. Once constructed, Visual Documents may be utilized to feed other systems within the enterprise (e.g., Customer Relationship Management (CRM) systems), or directly generate calls to action.

The described solution utilizes the best available technical underpinnings, tools, products and methods to actualize the availability of expert content.

At its foundation, the solution queries data from a high performance enterprise data warehouse characterized by parallel processing. This database can support both homogeneous (identical) and heterogeneous (differing but intersecting) databases. The system is adaptable for use with a plurality of third party database vendors.

A scalable advanced web server framework can be employed to provide the necessary services to run the application and deliver output over the web. A flexible and controllable graphics rendering engine can be used to maximize the quality and speed levels required to support both static and dynamic (which could be, for example, animated GIF, AVI or MPEG) displays. All components can operate with a robust operating system platform and within secure network architecture.

Pre-existing (and readily available) third party components can be employed to manage user security (e.g. operating system security), industry specific applications and OLAP (Online Analytical Processing) or other more traditional reporting. The described solution is designed to facilitate speedy and reliable interfaces to these products.

A predictive modeling interface assists the user in analyzing forecasted outcomes and in ‘what if’ analysis.

Strict security, testing, change and version control, and documentation standards can govern the development methodology.

Many organizations are facing massive and increasing amounts of data to interpret, the need to make more complex decisions faster, and accordingly are turning to data visualization as a tool for transforming their data into a competitive advantage. This is particularly true for high-performance companies, but it also extends to any organization whose intellectual property exists in massive, growing data sets.

This clash of (a) more data, (b) the increased complexity of decisions and (c) the need for faster decisions was recently recognized in an IDC White Paper (Gantz, John et. al.; IDC White Paper; “Taming Information Chaos: A State-of-the-Art Report on the Use of Business Intelligence for Decision Making” November 2007), which described this clash as the “Perfect Storm” and that this ‘storm’ will drive companies to make a quantum leap in their use of and sophistication in analytics.

Today's business tools and the way they operate barely allow business users to cope with historical internal data, let alone internal real time, predictive, and external data.

Hence, a new paradigm in business intelligence solutions is required.

### System Overview

As explained above, FIG. 2A shows a high-level overview of the system.

There are five key components to the system. These are:

### 1. Visual Documents;

### 2. Visual Designs;

### 3. Business Performance Drivers (and BPD Packages);

### 4. Spatial Maps;

### 5. Application Components.

A description of each of these components is set out below under the respective headings.

### Visual Documents

The Visual Documents form the core of the solution from a user perspective. This may include visualization(s), associated data and/or metadata (typically the visual form) that the user defines requests and interacts with. The Visual Documents may consist of single frames or animated frames (which could be, for example, implemented in AVI, GIF or MPEG format or a sequence of still images).

The Visual Document is typically viewed in a dynamic web browser view. In this interactive view the user may observe, select and navigate around the document.

Once created, the Visual Documents may be stored in the database and may be distributed to key persons (printed, emailed etc.) or stored for later use and analysis.

### Visual Designs

The Visual Designs are a classification of the different types of visualizations that a user may choose. Within each Visual Design category, there are a number of visualizations. For example, the ‘spatial’ category can have retail store location maps, network maps or geographical location maps, such as, for example, maps available from Google™ or Yahoo™.

The described system allows users to select one or more visualizations (e.g. one visual form within a Visual Design category) to create a Visual Document.

There are ten Visual Design categories defined below, however it will be understood that further Visual Designs are envisaged, as well as the number of visualizations within each classification and the number of classifications.

Visual Designs are a classification of the different types of visualizations that a user may choose. Within each Visual Design, there are a number of visualizations.

For example, the ‘spatial’ category can have retail store location maps or geographical location maps.

The visual design types include:
Hierarchical
Temporal
Spatial
Textual
Virtual
Structural
Classical
Pivotal
Navigational
Interactive

### 1. Hierarchical Visual Designs

One purpose of a hierarchical visual design is to present large scale hierarchical data in one display. It is a picture for understanding, monitoring, exploring and analyzing hierarchical data.

Key elements of hierarchical visual designs are:
Data is hierarchical.
Structure of data can determine hierarchy.
They can be overlaid with connections.

This type of visualization may be automatically generated from a table of contents. This automatically generated hierarchy then becomes a special layer over which specific information can be overlaid.

The Hierarchical Visual Design is a hierarchical diagram such as an organizational chart or a correlation matrix.

This Visual Design has at least one natural centre and typically has a higher density toward the fringes of the visualization. The Hierarchical Visual Design can typically be considered as a ‘tree’ structure. The nodes and vertices within the tree structure are best if they are generated automatically from a dataset. This tree structure is a good example of a Special Layer.

The development process will include building a tree that is optimized for this type of Visual Design including heat mapping techniques.

Large scale hierarchical data is represented using various techniques such as mapping to icons, shapes, colors and heights.

Typical uses include mapping of web pages, organizational charts, decision trees and menu options.

### 2. Temporal Visual Designs

One purpose of a temporal visual design is to present temporal based data, such as, for example, revenue per day, in a specially designed calendar or time series view. This calendar view will enable users to view thematic layers that display BPD information such as revenue or sales.

This type of visual design is a completely data defined Visual Design. The key input values are typically ‘start’ and ‘end’ dates along with the ‘number’ of variables to be displayed.

The simplest, and potentially the most useful, Visual Design Special Layer may be a carefully drawn calendar. The calendar may then become a useful Visual Design for date-based Visual Documents.

Temporal analysis is one of the fundamental methods of almost all analysis. Using temporal high density visualizations, users will be able to overlay high density Thematic Layers on well designed Special Layers such as the spiral data visualization shown in the above examples. This analysis can be applied in everything from customer frequency and spend analysis to analysis of the impacts of time of day on the management of a mobile phone network.

It is considered that temporal design patterns are particularly important in terms of analytics as the majority of analytics are time based. Described herein are several examples of producing temporal visual designs.
Non Contiguous Time—For example, weekends can be represented in some interesting ways. The simplest way being not to show them.
Non-linear Time—This allows multiple years of history to be shown where the oldest data is spatially compressed in the Visual Design.
Temporal Special Layers—These can be used to compare quite disjointed types of data. For example, the relationship between external public events, operational payroll sizes and sales revenue. There exists no easy way to numerically join this data together, visually this data can be joined. The technique combines well with simple correlations as it is possible to combine these distinct datasets to show correlations.
Control—One important consideration in visualizing temporal data is the gaining of scientific control. For example, seasonal variables. This is particularly interesting as one year is always different from the next. Quite simply, the start date of each year is never the same as the next, and moving external events such as Easter and ‘acts of God’ such as weather make precise comparison very difficult.

### 3. Spatial Visual Designs

One purpose of a spatial visual design is to present an overview of large scale numerical data in one spatial display (i.e. a space) for understanding, monitoring and analyzing the data in relation to a space.

This type of visual design combines together base maps provided by third parties with rendered thematic layers. These “mash-ups” are user definable and accessible to users.

For example, third party base maps may include customer-owned spatial maps or readily available base maps such as those provided by Google™ Maps or Yahoo™ Maps. The system provides powerful thematic layers over one of these spatial base maps.

One example of a spatial visual design is available at www.weather.comⁱⁱⁱ. This map shows two layers—(1) an underlying heat map overlaid with (2) actual temperature at specific cities. The points are useful as the state boundaries allow the user to determine with relative ease which city is being referenced. The underlying heat map is useful as it allows the user to see the overall trend at a glance.

A second example is available at Information Aesthetics^{iv}. This example shows the travel time from the centre of London outwards using various methods of travel. The use of heat maps here shows very clearly the relationship between distance from the centre of London and travel time.

In a further example, the ‘spatial’ category of visual design can have retail store location maps, network maps or geographical location maps, such as, for example, maps available from Google™ or Yahoo™

Numerical data may be independently mapped using parameters such as hue, saturation, brightness, opacity and size distributed across a defined geographical space.

Geographic mapping has a wide range of uses. In fact with the wide availability of high quality base maps, the world is becoming spatially enabled. Mapping applications can be used for a huge variety of tasks, from customer relationship management to drive time analysis, site selection to insurance risk analysis and telecommunications network analysis.

### 4. Textual Visual Designs

One purpose of textual visual designs is to enable business users to interact and query seamlessly from the structured to the unstructured world.

While it is possible to do basic numeric analysis on variables such as hit frequency and number of clicks per hour, the key method is to use a special layer to construct a sensible schematic of the unstructured data then overlay BPDs. Simply put, the described solution will leverage information visualization to bring structure to the unstructured world.

For example, a heat map may be used as part of a textual visual design.

Unstructured textual information is a huge area of growth in data storage and intuitively, the business intelligence industry expects this data to become a valuable asset. The described solution provides information visualization capabilities that overlay and draw out the non-numeric, but actionable, observations relating to unstructured data, in order to link the numeric data warehouse to the unstructured world.

There are a multitude of Special Layers that may be used with textual data. These textual Special Layers extend from building self organizing maps of textual information to diagrams showing the syntax hierarchy of the words used in a document.

A self organizing map (SOM) consists of components called nodes or neurons. Associated with each node is a weight vector of the same dimension as the input data vectors and a position in the map space. The usual arrangement of nodes is a regular spacing in a hexagonal or rectangular grid. The self-organizing map describes a mapping from a higher dimensional input space to a lower dimensional map space. The procedure for placing a vector from data space onto the map is to find the node with the closest weight vector to the vector taken from data space and to assign the map coordinates of this node to our vector—Source: WikipediaError! Bookmark not defined.

### 5. Virtual Visual Designs

One example of a virtual visual design is a 3D representation of a virtual environment. 3D worlds generate far more accurate and complete data than the real world. As these 3D worlds grow in popularity and become more immersive, the potential for business intelligence tools to be applied to this environment grows significantly.

One example application of the use of a virtual visual design is a retail space analysis tool where transaction data is under-laid as the color of the carpet or shelves. In the case of the shelves, the shelves can also show representations of the products on the shelves.

### 6. Structural Visual Designs

One purpose of a structural visualization is to illustrate the structure of the data. For example, network topology or interconnection between data elements. The interconnections in the examples below show how a simple Special Layer construct can be used to illustrate quite complex connections.

One example of a structural type visual representation is that of the London underground map. The London underground map is a key historic map showing the schematic topology of the London underground. Using this map travelers can intuitively plan out complex routes and interconnects. Without this visualization, navigating the London underground system would be significantly more difficult and complex to understand.

These structural visualizations are very powerful and are closely related to spatial visualizations. Most of the thematic treatments that can be applied to a spatial visualization are equally applicable to a structural visualization.

Examples of uses for such a visual design type would be for visualizing call routing across a network, electricity grid management and route optimization.

It will be understood that a wide variety of Special Layers may be created in this space. These Special Layers essentially generate the structural schematic from the base data.

Typically the interconnections between nodes are used to generate the structure. One important aspect of the structural Special Layer is building the structure in such a way that interconnect line crossing is minimized.

### 7. Classical Visual Designs

Traditional charts provide a simple, common and well-established way of presenting data using classical visual designs. However, traditional charts are user-skill dependent and the herein described system may be used to apply guided Visual Design techniques to traditional charts to significantly extend their usefulness.

One example would be to show a line chart of Speed Vs Time in a simple two dimensional line graph. This type of basic graph shows the data clearly and allows the user to observe any geometric trends.

Some common charts that fall into this design category are as follows:
Scatterplots—Are Cartesian coordinates to show the relation of two or more quantitative variables.
Histograms—Typically show the quantity of points that fall within various numeric ranges (or bins).
Bar graphs—Use bars to show frequencies or values for different categories.
Pie charts—Show percentage values as a slice of a pie.
Line charts—Are a two-dimensional scatterplot of ordered observations where the observations are connected following their order.

### 8. Pivotal or Quartal Visual Designs

Different visualization methods have been suggested for high-dimensional data. Most of these methods use latent variables (such as principal components) to reduce the dimensionality of the data to 2 or 3 before plotting the data. One problem with this approach is that the latent variables sometimes are hard to understand in terms of the original variables.

The parallel coordinate (PC) scheme due to Inselberg and others attempts to plot multivariate data in a completely different manner. Since plotting more than 3 orthogonal axis is impossible, parallel coordinate schemes plot all the axes parallel to each other in a plane. Squashing the space in this manner does not destroy too much of the geometric structure. The geometric structure is however projected in such a fashion that most geometric intuition has to be relearned, this is a significant drawback, particularly for visualization of business data.

Pivotal or Quartal visual designs allow the user to display higher dimensional data in a lower dimensional plot by ranking and splitting variables across various axes. This method may for example be used to display 3D data in a 2D plot.

### 9. Navigational Visual Design

Navigational visualizations use a highly visual interface to navigate through data while maintaining the general context of the data. This data visualization method may use other visual design types so it is differentiated more by the style of how it is used than the implementation standard.

Photosynth for example is a powerful navigational tool for moving between images, its display is designed for navigation of large numbers of linked images.

One illustrative navigational representation example is shown by Ubrowser. This navigational visualization example shows web pages represented in a geometry design. The web pages can be navigated through by spinning the cube shown in the example.

Navigational visualizations are designed for users to interactively move through the data. The objective of the visualization is to present a large volume of data in such a way as to enable users to move through the information and gain an understanding of how the data links together.

A number of display techniques are known for displaying information with regard to a reference image (the combination referred to as primary information). Where the limit of primary information is reached a user may wish to know more but be unable to further explore relevant information. A user may also simply wish to explore other aspects although there is more primary information to explore.

A key element of navigational visual designs is that they are interactive and are designed to assist in data navigation and data way-finding rather than for analytical purposes.

### 10. Interactive Visual Designs

This classification is for significantly advanced or interactive visual designs which do not fit within the preceding classifications.

These visualizations vary in nature from pure abstract forms to more tangible forms of visualizations. The key difference is that these visualizations may not be classified within the preceding Visual Design classifications due to their advanced nature or interactivity.

Any Visual Design layer considerations will be dependent on the interaction being considered.

There is opportunity to use common associations to provide iconic views of key events; the common associations are created using the interactive tools and asking users for feedback on the relevant icons. This feedback is then developed into a learned interactive system to provide iconic data representations.

Eye movement sensors can be used to control the interactivity and to learn information about relevant icon usage and control interactivity.

A wide range of user interfaces are used in conjunction with computer systems. Generally these are simply used to provide command or data inputs rather than to analyze the underlying behavior of a user in the context of the operation of a software application.

It would be desirable to operate software applications running on a computer on the basis of observed user behavior in the context of a software application.

### Business Performance Drivers (and BPD Packages)

Business Performance Drivers (BPDs) are a metric applied to data to indicate a meaningful measurement within a business area, process or result. BPDs may be absolute or relative in their form of measurement.

The Business Performance Driver (BPD) concept differs from the known KPI concept by introducing BPDs that

(1) may have multiple dimensions,
(2) place the BPD in the context of the factors used to calculate them,
(3) provide well understood points of reference or metadata around which visual document creation decisions can be made, and
(4) may contain one or more methods of normalization of data.

Common groups of BPDs are called BPD Packages. For example, BPDs relating to one industry (say, telecommunications) can be grouped into one BPD Package. BPDs may be classified into one or more BPD Packages. For example, Net Revenue with normalizations available of per customer or per month may be applicable in a number of industries and hence, applicable to a number of BPD Packages.

### Spatial Maps

Spatial maps allow for a user-owned and defined spatial map and/or for the user to use publicly available context maps such as Google™ Maps or Yahoo™ Maps. In either case, the user can display selected BPDs on the chosen spatial map.

Typically, a user-owned spatial map may be the inside floor space of a business and a publicly available context map may be used for displaying BPDs on a geographic region e.g. a city, county, state, country or the world.

### Application Components

The described application includes two main components, the Application Servers and the Application Infrastructure.

The Application Server includes a number of servers (or server processes) that include the Rendering Engine (to make (or render) the Visual Documents), Metadata Servers (for the BPD Packages, the Visual Designs and the BPDs) and the Request Queue.

The Application Infrastructure is also comprised of a number of servers (or server processes) that may include a Listener (which ‘listens’ for document requests) and central error logging.

Based on the user selections made above (Visual Documents, Visual Designs and BPDs), the user can click on an action and send a communication to a third party system (CRM, Business Intelligence or other application). The third party system could, for example, load the list from the solution and then send out a personalized email to all members on that list.

According to one embodiment, the described server components of the application are a Java based application and utilize application framework such as the IBM™ WebSphere application server framework, other platforms and server applications may be utilized as alternatives. The client application may be a mashup that utilizes the server components or it could be a rich internet application written using the Adobe™ Flash framework.

Other key elements of the system may include:
Parallelism—Parallel processing to increase responsiveness or to increase workload scalability of queries or Visual Documents. This parallelism may also decrease response time for larger visual documents in particular animated images may be executed in a parallel fashion.
Security—System and user-access security. This security may be a combination of authorization and authentication. The security framework may be implemented using the application framework.
Map Updates—A map management tool to update user-owned spatial maps.
Predictive Modeling—This may be an interface to third-party predictive models.
Configuration Tools—The application may be supported by configuration tools to enable rapid deployment of the application.

### Modular Overview

### Module Descriptions

The diagram shown in FIG. 2B shows an overview of the software modules in the described system.

These modules are described in the subsequent table. More detailed descriptions and diagrams of each of the software modules are provided below.

The table below outlines the following four items in relation to each module:
1. Technology System Component: This is the name given to the system component; this name matches the name in the above diagram.
2. High Level Functional Description: Describes the role of the software module.
3. Caching: Indicates whether this module uses caching to optimize performance.

| Technology | | | |
|---|---|---|---|
| System | | | |
| Component | | High Level Functional Description | Caching |
| 1. | Rendering | Produces images and animations; could use | Yes |
| | Engine | Google ™ Maps or Yahoo ™ Maps for spatial context map. | |
| | | The development of Special Layers enables | |
| | | Visual Document produced to have unique | |
| | | capabilities that were not previously readily | |
| | | available. | |
| 2. | Parallelism | Enables parallel execution of requests for high | Yes |
| | Engine | volume of Visual Document output and rapid | |
| | | results delivery to users. | |
| | | The preferred application framework selected | |
| | | is the IBM ™ WebSphere product. | |
| | | This framework enables the application to be | |
| | | scaled across multiple servers. | |
| 3. | Map | Provides key map editing features | Yes |
| | Management | (specifically CAD like) and map version | |
| | Tool | control (desktop and enterprise) tools. | |
| 4. | OLAP | Industry standard online analytical reporting. | Yes |
| | Reporting | For example, sorting, filtering, charting and | |
| | | multi-dimensional analysis. | |
| | | It is desirable that the user interaction with the | |
| | | data selection process in the data view is | |
| | | seamless with the data visualization view. For | |
| | | example, if the user selects 5 customers from | |
| | | the data view, the same 5 customers should be | |
| | | selected in the visualization view. This means | |
| | | that the solution may be a hybrid view (as | |
| | | discussed later). This hybrid view is a ‘simple’ | |
| | | view and is an interface to an industry leading | |
| | | OLAP tool. One option includes interfacing to | |
| | | the OLAP tool via a JDBC interface from the | |
| | | described solution or a web service model for | |
| | | the selection management. | |
| 5. | Predictive | An interface to external predictive modeling | Yes |
| | Modeling | engines; may also have some modeling | |
| | System | systems. For example, Self Organizing Maps | |
| | | (SOM). | |
| 6. | Visual Design | Tools for users to manage the different Visual | No |
| | Management | Designs. | |
| | System | | |
| 7. | BPD | Tools for users to manage the different BPD | No |
| | Management | Packages and their associated BPDs. | |
| | and Data | Contains Data Access capability that enables | |
| | Access | data to be queried from RDBMS (or | |
| | System | potentially other data sources). | |
| 8. | Output | For management of the documents (Visual | Yes |
| | Management | Documents) within the system. | |
| | System | | |
| 9. | Infrastructure | Core system management functions including | Yes |
| | | system logging and Request Queue | |
| | | management. The Request Queue is also | |
| | | described under parallelism and there may be | |
| | | crossover between these two module | |
| | | descriptions. | |
| 10. | Security | Enables access to the system (or parts thereof) | No |
| | | to be properly controlled and administered. | |
| 11. | Interfaces | Allows services to be called by (or to call) | No |
| | | external applications. | |
| 12. | Implementation | Tools to deploy and configure the software | Yes |
| | Tools | system. | |

### Architectural Views of the System

This section contains descriptions and diagrams of the architectural views of the system. The architecture shows how the system components fit and operate together to create an operational system. If compared to a vehicle, the wiring diagrams, the physical body, the driving circle and key complex components like the engine would be shown in architectural views.

This view does not describe how the system is written; it describes the high-level architectural considerations.

Architectural considerations are typically implemented by one or more software modules. The modular view described herein lays out a high-level view of how the software modules are arranged.

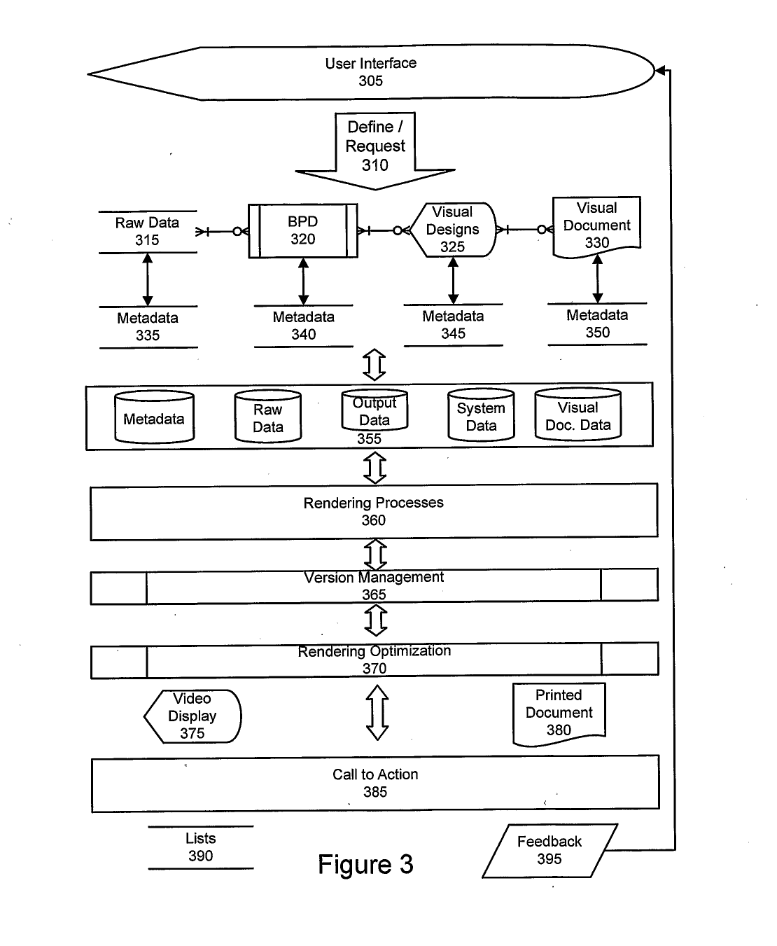

FIG. 3 shows a general overview of the data flow within the system.

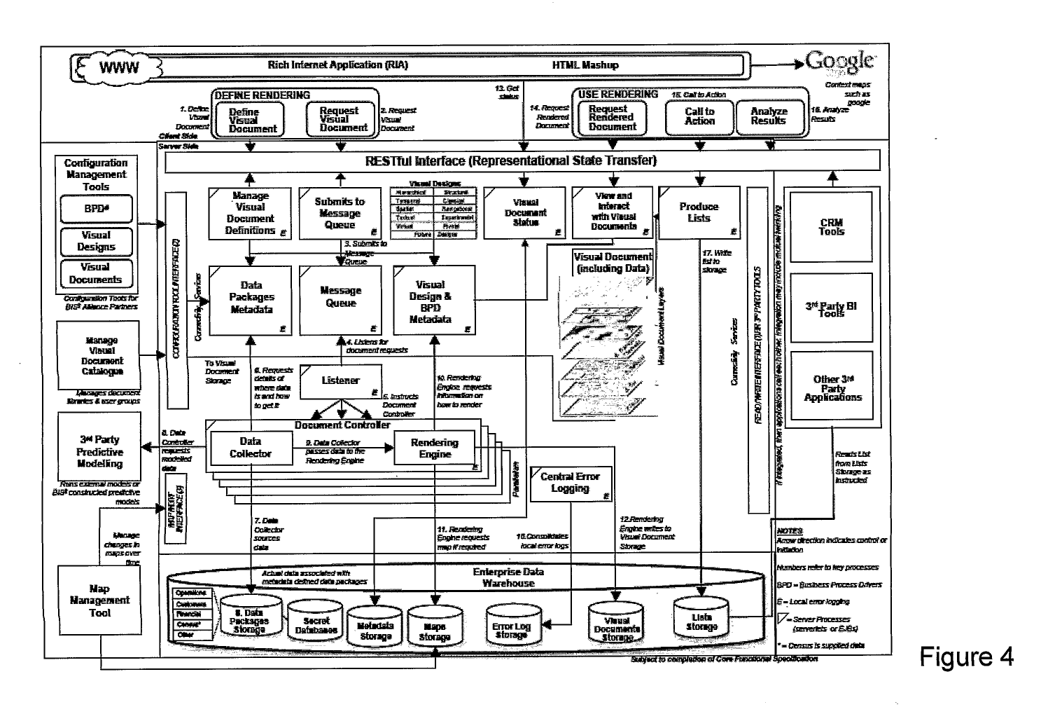

FIG. 4 shows the architectural overview of the described solution. This diagram is elaborated by the diagrams and descriptions in following sections of this document.

The following modules or components are shown:

Web interface Module 4105: User interfaces are browser based or may be a web services client, a rich internet application or may be a thick client. In all cases the user interface uses the same interface to the back end services.

Rendering Definition Module 4110: The user interface is used to define and request the rendering of Visual Documents

Rendering Use Module 4115: Visual Documents are used for analysis, and precipitate calls to action.

Connectivity Services Module 4120: The definition and rendering of Visual Documents is performed through a set of programs or services called the Connectivity Services.

Configuration Management Tools Module 4125: Multiple versions of the basic elements; BPD, Visual Design, Visual Documents; are managed by a set of programs called the Configuration Management Tools.

Visual Document Management Catalog 4130: One such Configuration Management Tool (4125) is a set of programs that manage a users' catalog of available Visual Documents.

Predictive Modeling Module 4135: Predictive modeling is used for forecasting unknown data elements. These forecasts are used to predict future events and provide estimates for missing data.

Map Management Tool 4140: Another of the Configuration Management Tools (21125) is the Map Management Tool. It is designed to manage versions of the spatial elements of a visual design such as a geographic map or floor plan.

Visual Document Definitions Management Module 4145: Visual Document Definitions are managed through the use of metadata (4175).

Message Queue Submission Module 4150: Requests for Visual Documents are handled through queued messages sent between and within processes.

Visual Design Type Module 4155: Visual Documents are comprised of one or many Visual Designs in these categories.

Visual Document Status Module 4160: The status of Visual Documents is discerned from the metadata and displayed on the user interface.

Interaction and Visual Document View Module 4165: The user interacts with the Visual Documents through the user interface, and appropriate changes to and requests to read are made to the metadata.

List Production Module 4170: Where additional output such as customer lists are required, they are requested using the user interface and stored in the EDW (4215).

Data Packages Metadata Module 4175: Metadata is used to describe and process raw data (data packages).

Message Queue Module 4180: Messages may be queued while awaiting processing (4150).

Visual Design and BPD Metadata Module 4185: Metadata is used to describe and process the BPD's and Visual Designs associated with a particular Visual Document.

Visual Documents Module 4190: Visual Documents may be comprised of layered Visual Designs.

Third Party Modules 4195: Visual Documents may be used with or interact with other third party tools.

Listener Module 4200: The listener processes messages (4150) in the message queue (4180)

Document Controller Module 4205: The document controller is used to provide processed data to the rendering or query engines.

Central Error Logging Module 4210: System errors are detected and logged in the EWP (4215).

EDW 4215: All data is typically stored on a database, typically, multiple fault tolerant processors in an Enterprise Data Warehouse.

The following architectural components are described in more detail.

| Architectural Component | Description |
|---|---|
| Connectivity | This is a common communication service that is used |
| Services | when sending messages between systems (i.e. the |
| | described solution and 3^{rd} party tools) and between the |
| | described application layer and the user interface layer. |
| Configuration | Allows specialized users to configure Visual Designs and |
| Management | Visual Documents to their needs - which differ from the |
| Tools | default configuration provided. |
| Manage Visual | Gives selected users the ability to search, sort, group, and |
| Document | delete Visual Documents in the Visual Document |
| Catalog | Catalog. |
| Predictive | External modeling systems that use data sent from the |
| Modeling | described solution to perform complex calculations to |
| | produce predictive data. This predicted data is piped |
| | through the described solution to the user. |
| Map Management | This is an application that enables users to create modify |
| Tool | and delete individual maps to manage the complete |
| | sequences, this is very appropriate for management of |
| | floor plans. |
| Data Packages | The services responsible for providing metadata that |
| Metadata | enables the requester (typically, Data Collector) to source |
| | the data for the BPD. |
| Visual Design & | The services responsible for providing the metadata to the |
| BPD Metadata | requester (typically the Rendering Engine) that enables |
| | the construction of the Visual Documents. |
| Request Queue | The Request Queue manages the communication of |
| | requests for rendering of Visual Documents. These |
| | communications may be scheduled. |
| Document | The Document Controller consists of two components. |
| Controller | The first is the Data Collector responsible for reading the |
| | appropriate metadata and retrieving the data from the |
| | EDW (Enterprise Data Warehouse). This data is passed |
| | to the Rendering Engine that is responsible for producing |
| | the Visual Document. Document Controllers run parallel |
| | Visual Document requests, build and store documents. |
| Read/Write | The described solution provides a common interface for |
| Interface for 3^{rd} | 3^{rd} party tools to communicate with e.g. CRM |
| Party Tools | applications. |
| 3^{rd} Party BI Tools | One of the 3^{rd} party tools that the described solution may |
| | integrate with is an external OLAP tool. |
| Secret Databases | Secret databases are a method of sharing encrypted |
| | databases and providing a SQL interface that enables end users |
| | to run queries against atomic data without |
| | discovering the details of the data. |

The following terms have been also been used in FIG. 4. These are explained in more detail below.

| Architectural | |
|---|---|
| Component | Description |
| Logging | Logging (for example, error logging and access |
| | logging) is an inherently difficult activity in a |
| | parallel independent and predominantly stateless |
| | system. |
| | The main issue that arises is that logging presents |
| | potential links between systems and therefore |
| | dependencies. |
| | Typically within the application, each server will be |
| | responsible for its own logging. This ensures that the |
| | system scales without degradation in performance. |
| | A separate process (central log reader) may be used |
| | to consolidate these logs dynamically as and when |
| | required. |
| Web Server | Web Servers respond to requests from users to |
| | provide Visual Documents. They read any required |
| | information from the metadata servers and Visual |
| | Document storage servers. If necessary they write |
| | Visual Document requests to the Request Queue. |
| Metadata | Metadata servers are responsible for storage and |
| Servers/Storage | user views of metadata. The metadata servers are |
| | also responsible for the validation of user rights to |
| | read Visual Documents (within the application). |
| Visual Document | The Visual Document Catalog is a secure storage for |
| Storage | all Visual Documents. Access is only possible when |
| | security requirements are met. |
| Data Collector | Typically the data collector queries the customer's |
| | data warehouse. The data warehouse can be |
| | augmented with additional subscribed |
| | embellishment data. This will provide the raw data |
| | that is represented visually back to the user. |
| BPD Packages | The described solution will use metadata to define |
| Metadata | groups of BPDs. These groups of BPDs are called |
| | BPD Packages. BPD Packages enable both internal |
| | data measures to be efficiently installed and external |
| | datasets to be provided. |
| | BPD packages contain no data. |

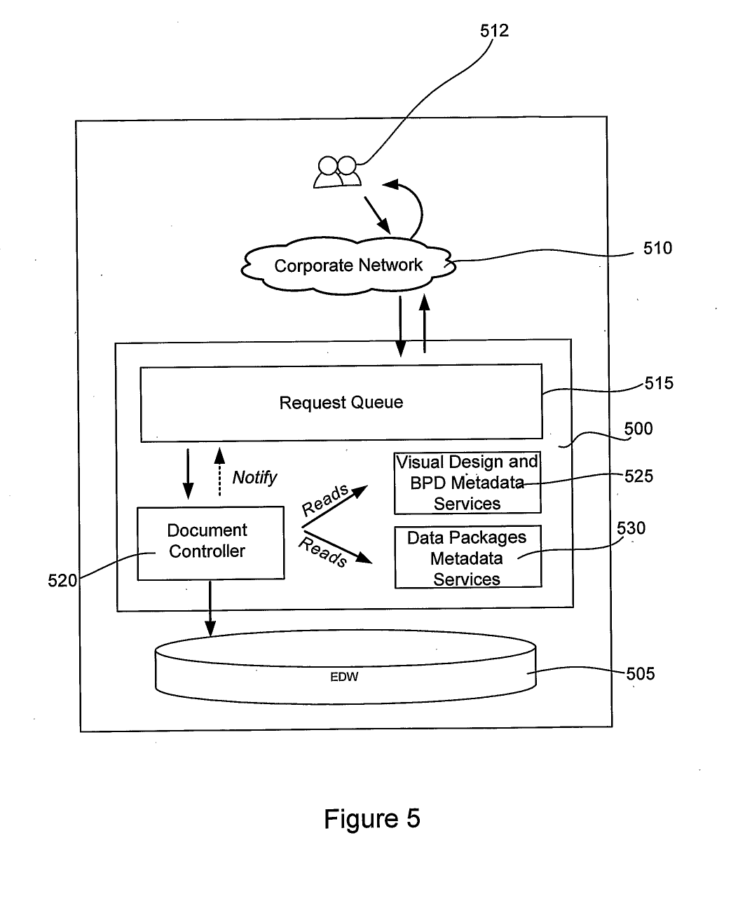

A further high-level system delivery overview of the solution is set out as shown in FIG. 5.

The described solution 500 is hosted by the enterprise 510. The figure shows the logical flow from the submission of a request to the end result, viewing the rendered Visual Document.

The data being visualized belongs to the customer 512 and the submitted request is unknown to the entity running the visualization system 500.

The controlling entity, integrators and customers may wish to have summaries of technical performance data (usage patterns, errors etc) sent from the operational system back to the integrator or controlling entity.

The system 500 has access to the data in a EDW 505. The system utilizes a request queue 515 to control requests from a corporate network 510. These requests are forwarded to a document controller 520. The document controller 520 accesses both the EDW 505 and reads visual designs and BPD metadata services 525, as well as data packages metadata services 530.

The system described thus enables various methods to be performed. For example, data is transformed into visually interpretable information. The visually interpretable information is in the form of visual representations that are placed within one or more visual documents.

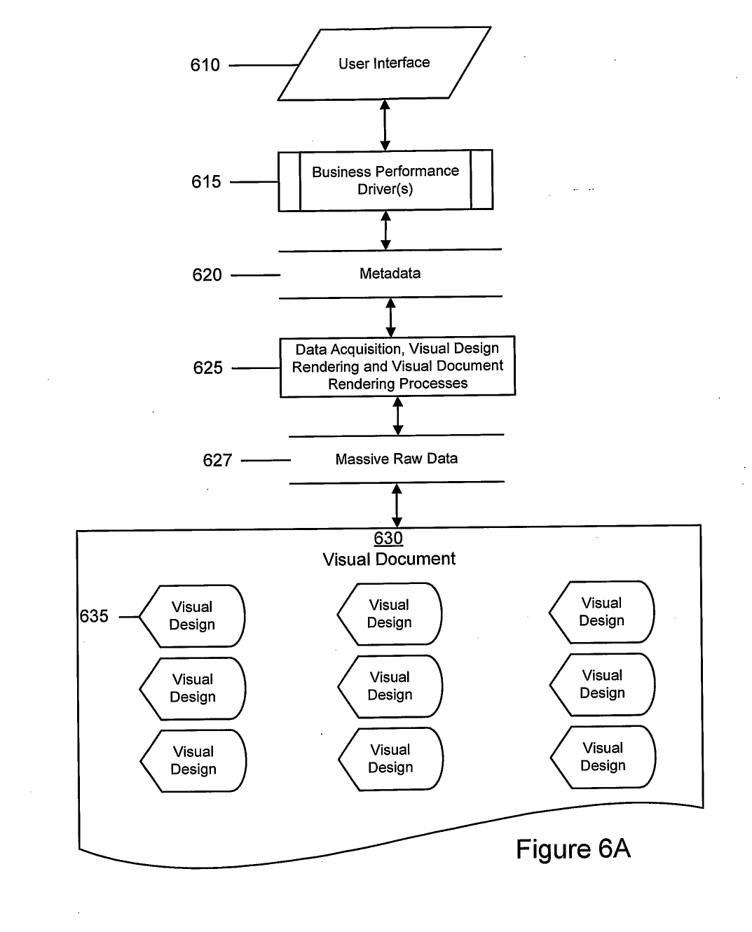

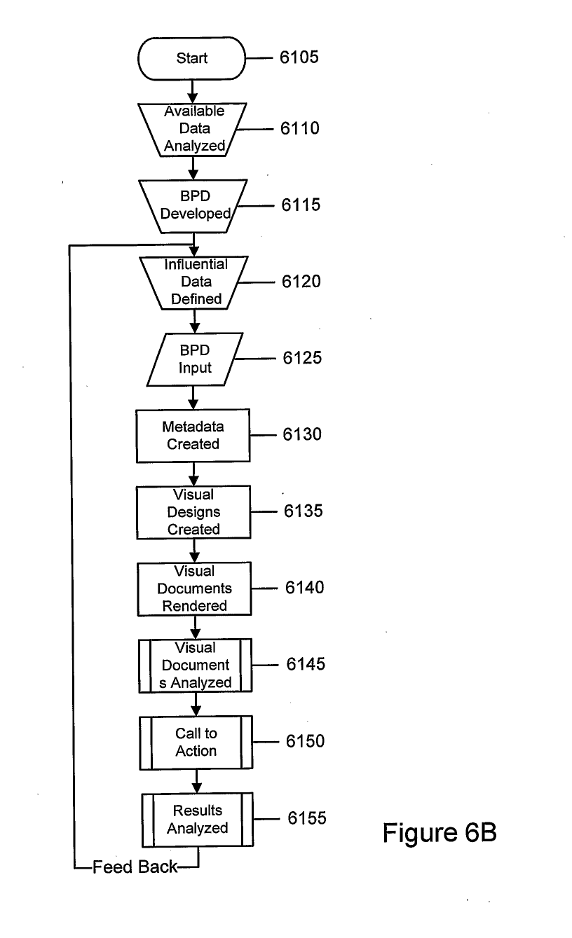

FIG. 6A shows a general data flow diagram for the described system.

The User Interface 610 allows the user to define BPD's 615 in terms of raw data 627, which become the focus of the Visual Document 630.

Further, the User Interface 610 allows the user, through automated expert help, to create the Metadata 620, the most appropriate Visual Designs 635 that make up the Visual Document 625 in order to provide detailed analysis of data related to the BPD 615. The data acquisition, visual design rendering and visual document rendering processes utilize massive amounts of raw data 627.

The Metadata 620 is used by the Processes 625 to optimize the acquisition of the appropriate Data 627, processing of the data into useful information, and to optimize the creation and rendering of the Visual Designs 635 and the Visual Document 630 that contains them.

This method includes the steps of providing comprehensive yet easy to understand instructions to an end user that has accessed the system and the visual design application. The instructions assist the end user in obtaining data associated with a theme, wherein the theme may be focused on objectives that have been derived from the data. The objectives may be business objectives, for example. In this way, the system guides a user carefully through the many choices that are available to them in creating the visual representations, and the system automatically tailors its instructions according to not only what the user requires, but also according to the data that is to be represented. The system focuses on providing instructions to enable a visual representation to be created that will enable an end user to more effectively understand the data that has been collated. Further, the instructions assist the end user in determining one or more summaries of the obtained data that enable the end user to understand the theme, as well as organizing the determined summaries into one or more contextual representations that contribute to the end user's understanding of the theme.

Further, instructions are provided that assist an end user in constructing one or more graphical representations of the data, where each graphical representation is of a predefined type, as discussed in more detail below, and includes multiple layers of elements that contribute to the end user's understanding of the theme.

Finally, instructions are provided to assist an end user in arranging the produced multiple graphical representations in a manner that enables the end user to understand and focus on the theme being represented as well as to display or print the organized graphical representations. The system assists in the organization or arrangement of the representations, elements thereof, within the visual document so as to ensure certain criteria are met, such as, for example, providing a suitable representation in the space available, using the minimum amount or volume of ink to create the representation, and providing a suitable representation that depicts the theme in a succinct manner, or visually simplistic manner.

The data being processed to create the graphical representations may be particularly relevant to the theme being displayed, disparate information or indeed a combination of relevant and disparate information.

There are multiple types of graphical representations that may be included within the visual document. The types are discussed in more detail below and include a hierarchical type, a spatial type, a virtual type, a classical type, a navigational type, a temporal type, a textual type, a structural type, a pivotal type, and an interactive type.

Further, the instructions may assist an end user in arranging the graphical representations in order to display high density data in a manner that conveys important information about the data, rather than swamping the end user with multiple representations that look impressive but do not convey much information.

In addition instructions may be provided to assist the end user in arranging the graphical representations to allow supplementary information to be added, where the supplementary information may be provided in any suitable form. Particular examples provided below depict the supplementary information being provided in subsequent visual layers that overlay the graphical representation. Alternatively, or in addition, supplementary information may include additional elements to be displayed within a single layer of the representation, for example, in the form of widgets.

FIG. 6B shows a flow diagram according to this embodiment of the invention.

Step 6105: Process Starts. User decides to manage the business.

Step 6110: Available data is identified and analyzed.

Step 6115: Business Process Drivers (metrics defined in terms of the data to indicate a meaningful measurement within a business area, process or result).

Step 6120: Data influencing the BPD metrics are identified.

Step 6125: BPD's are input into a computer system

Step 6130: BPD is categorized and appropriate metadata describing it is generated.

Step 6135: Visual Designs to display the influential data are created.

Step 6140: Visual Designs are aggregated into Visual Documents and rendered. Adjustments are made based on the freshness of all components (e.g., BPD, available data).

Step 6145: Visual documents are analyzed by the end user.

Step 6150: The end user decides on and implements actions based on the analysis in 6145.

As touched on above, business performance drivers (BPDs) are used to enable more efficient data analysis so as to produce accurate and relevant visual representations of the data. A BPD is a form of advanced business measure wherein additional information is included within the BPD that enables the system using the BPD to understand how to manipulate the BPD. That is, one or more intelligent attributes are included with the business measure to form the BPD, where those attributes reference or include information on how the BPD is to be processed or displayed. The form of processing and display may also be varied according to the device type or media upon which the business measures are to be displayed.

The attributes are attached to the business measure by storing the BPD in the form of a mark up language, such as, for example, HTML or XML. It will however be understood that any other suitable format for storing the BPD may be used where the attributes can be linked to the business measure.

In the example of HTML, the attribute is included as a tag. One such example would be to include the data or business measure within the body of the HTML code and follow the business measure with a tag that references the attributes, or dimensions, associated with that business measure.

Further, the attributes may also be modified or deleted, or indeed new attributes added, during or after the processing of the BPD so that the attributes are maintained, or kept up to date, bearing in mind the requirements of the entity using the BPD to visualize their data.

The business performance drivers, or measurable business objectives, are identified in order to create graphical representations of the business objectives, where those representations are placed within a visual document. A business objective may be, for example, a metric associated with a business.

Instructions are provided by the system to the end user, in order to assist the end user in establishing multiple business objectives as functions of available metrics, as well as assisting the user in organizing the business objectives into a contextual form that contributes to the end user's understanding of the business objectives.

Further, instructions are provided to assist the end user in constructing one or more graphical representations of the business objectives, where each graphical representation is of a predefined type, as mentioned above and described in more detail below. Further, each graphical representation includes multiple layers of elements that contribute to the end user's understanding of the business objective.

The elements within the graphical representation may include, for example, a shape, position, color, size, or animation of a particular object.

Instructions are also provided by the system to assist the user in arranging multiple graphical representations in a suitable manner that enables the end user to understand and focus on the business objectives being represented.

Finally, the end user is also assisted with instructions on how to display the organized graphical representations.

The following section describes a method of creating a visual representation of data in the form of a visual design.

The method includes the steps of the system providing instructions to an end user to assist the end user in constructing multiple graphical representations of data, where each graphical representation is one of a predefined type, as defined above and explained in more detail below, and the graphical representation includes multiple layers of elements that contribute to the end user's understanding of the data

The system also provides instructions to an end user that assist the end user with arranging multiple graphical representations of different types within the visual representation in a manner that enables the end user to understand and focus on the data being represented, as well as providing instructions to assist the end user in displaying the visual representation in a suitable manner.

The visual representation may be displayed in a number of different ways, such as on a color video screen or a printed page. The information that is forwarded to the display device to create the visual representation may differ according the type of display device so that the visual representation is produced in the best known suitable manner utilizing the advantages of the display device, and avoiding any disadvantages.

The data being displayed may be based on a measured metric or an underlying factor that affects a metric.

The elements within the graphical representation may include a shape, position, color, size or animation of a particular object.

Although a single visual document may include only one type of graphical representation, either in the form of multiple graphical representations or a single representation, there will also be situations where multiple types of graphical representations may be organized within a single visual document in order to convey different aspects of the data, such as, for example, temporal as well as spatial information. The inclusion of different types of graphical representations within a single document can provide an end user with a better understanding of the data being visualized.

Further, the single visual representation may be arranged to be displayed as an image on a single page or screen. This may be particularly useful where space is at a premium yet the user requires the visual representation to be provided in a succinct manner. For example, the user may request certain information to be displayed in a visual representation on a single mobile telephone display, or a single screen of a computer display, in order to show a customer or colleague the results of a particular analysis without the need to flick between multiple screens which can result in confusion, a waste of energy and ultimately a loss of understanding of the visual representations.

The same issue applies to printed representations, where the result of the system enabling a user to arrange a single representation, which may include multiple elements or layers, on a single page not only succinctly represents the data being analyzed but also saves the amount of paper being printed on and the amount of ink being used to print the document.

Further, the amount of ink required for a visual representation may be further reduced by providing instructions to the end user in a manner that directs them to control and use white space in a representation in an efficient manner so as to reduce the requirement of ink.

Multiple types of graphical representations may be merged together within a single visual document, or representation.

As mentioned above, instructions can be provided by the system to assist the end user in adding supplementary information to the visual representation, and the supplementary information may be provided in layers within the representation.

### Visualization Framework

The following description provides the visualization framework that will support embodiments of the present invention. The description includes an overview of the importance of Visual Design including a brief historical recount of a world-recognized leading visualization. The description also sets out the Visual Design classifications for the described solution.

It will be understood that the Visual Design examples described in this section are examples for illustrative purposes to identify the concepts behind how the visualization is produced. Therefore, it will further be understood that the concepts described can produce visual designs different to those specifically described. The Visual Design examples shown are also used to help the reader understand the narrative describing the Visual Designs.

The system described is specifically adapted to create actual specific visualization designs relevant to selected vertical and horizontal industry applications being deployed.

A vertical industry application is one that is associated with a solution directed at a specific industry, such as, for example, the entertainment industry. In this example, BPDs relevant to that industry are created, such as rental patterns of movies over different seasons.

A horizontal industry application is one that is associated with solutions across multiple industries. For example, the BPD may be based on CRM analytics, which applies across a whole range of different industries.

Design is now a fundamental part of almost every aspect of how people live work and breath. Everything is designed from a toothbrush to every aspect of a web site. Compare visual design to architectural design—in both cases anybody can draw quite complex pictures. The resulting pictures could have stimulating and well drawn graphic elements. In both cases, the question is why does the world need designers? Exploring this question more deeply one can ask—does it make such a difference to how one perceives and understands a design when it is made by a professional rather than an amateur?

The trend in business intelligence is to design tools to provide flexibility and leave the world of visual design to the amateurs. Stephen Few comments in Information Dashboard Design^{v} that “Without a doubt I owe the greatest debt of gratitude to the many software vendors who have done so much to make this book necessary by failing to address or even contemplate the visual design needs of dashboards. Their kind disregard for visual design has given me focus, ignited my passion, and guaranteed my livelihood for years to come.”

Visual Designs within the described framework are well thought through in how the data is displayed. The described system allows good information visualization design concepts to be captured and delivered back to users as Visual Documents using unique data processing and analysis techniques.

### Visual Designs

### Method or Visual Design Classifications

According to this embodiment, ten Visual Design types are defined and incorporated into the described system. It will be understood that additional Visual Designs may be further defined including the creation of certain examples and actual Visual Designs for specific industry applications.

The visual design types include:
Hierarchical
Temporal
Spatial
Textual
Virtual
Structural
Classical
Pivotal
Navigational
Interactive

The following describes a method for the assessment of Visual Design quality. In assessing the quality of a Visual Design the following factors should be considered:
Alternative approaches—To assess the capability of a Visual Design it is important to contrast it with other visualization methods. In particular one should compare the visual design to a classical graph or table of numbers. This comparison is important as many data visualizations add considerable graphic weight but little informational value.
Visual simplicity—Looking at a visualization should not overload the mind. The simplicity of the visualization is important as it enhances interpretation and allows common understanding without training. Some visualizations require considerable training to be applied. In general, the described solution will not use these visual designs.
Data density—the density of data in a visualization is a critical measure of its overall value. Higher density visualizations, if successful in maintaining their simplicity, have considerable potential to increase the flow of information to end users.
Volume of ink used—Is the visual design using negative space to show key information? This use of negative space allows lower volumes of ink to be used while showing the same or higher density of information. In addition, ink required is generally reduced as the number of “views” or pages of data is reduced to convey the same volume of data.
Capability to be illuminated with detail—In the end, data visualization becomes information visualization when the specific details are shown. The ability of a visualization to hold detailed information in specific places, often achieved with labels, is a key element in determining its value as an information visualization.

### Visual Design Layers

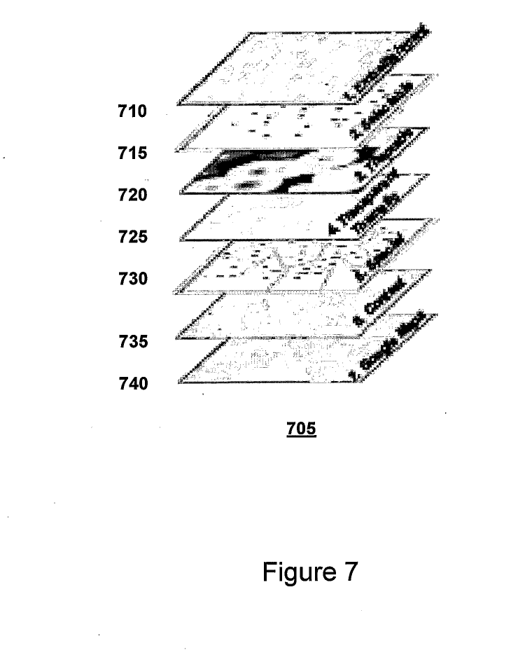

There are seven defined Visual Design Layers which are set out diagrammatically as shown in FIG. 7. Other visual design layers may be added as appropriate.

These seven Visual Design Layers are described in the following table:

| Visual Design | | |
|---|---|---|
| LayerType | | Description |
| 1. | Embellish- | Embellishment Layers have labels, symbology |
| | ment | and/or other detailed information that is used to |
| | Layers | illuminate information that is displayed in the lower |
| | | layers. The overlay can also include controls such |
| | | as progress bars or spark-lines. |
| 2. | Selectable | Selectable Layers are interactive and consist of |
| | Layers | items that can have associated data. On a retail |
| | | spatial map it includes store locations as they have |
| | | associated data. Selectable Layers are typically not |
| | | obscured by thematic treatments. |
| 3. | Thematic | Thematic Layers overlay colors or heatmaps on |
| | Layers | Special Layers. These thematic treatments become |
| | | the core visual impact of the final Visual |
| | | Document. |
| 4. | Transparent | Transparent Thematic Layers are very similar to |
| | Thematic | Thematic Layers (in fact are an alternative). The |
| | | only difference is that they are graphically merged |
| | | using a transparent overlay. For example, this kind |
| | | of layer is necessary to overlay heatmaps on |
| | | maps.google.com. |
| 5. | Special | Special Layers construct the structure of the data. |
| | Layers | Specifically the Special Layer understands how to |
| | | automatically draw the data so that other thematic |
| | | treatments can be applied. Special Layers include |
| | | mundane layers such as layers of polygons. |
| 6. | Context | These are the lowest level of the visualization; they |
| | Layers | include background maps and other contextual |
| | | information. |
| 7. | Context Map | This is a type of context layer that is rendered from |
| | Layers | a map such as Google ™ Maps, Yahoo ™ Maps etc. |
| | | This may be a road map, satellite map or any other |
| | | map. It is past as a set of tiled images and as such |
| | | can only be used as a Context Layer. Typically, a |
| | | Transparent Thematic Layer will be used to display |
| | | thematic data on a context map layer. |

In terms of the Special Layer, two examples of Special Layers are set out below:

### A. Classic Example of Special Layer: Voronoi Diagram

### Source: Wikipedia^{vi}

In mathematics, a Voronoi diagram, named after Georgy Voronoi, also called a Voronoi tessellation, a Voronoi decomposition, or a Dirichlet tessellation (after Lejeune Dirichlet), is a special kind of decomposition of a metric space determined by distances to a specified discrete set of objects in the space, e.g., by a discrete set of points.

In the simplest and most common case, in the plane, a given set of points S, and the Voronoi diagram for S is the partition of the plane which associates a region V(p) with each point p from S in such a way that all points in V(p) are closer to p than to any other point in S.

A Voronoi diagram can thus be defined as a Special Layer, where a set of polygons are generated from a set of points. The resulting polygon layer can then be subjected to thematic treatments, such as coloring.

### B. Non Traditional Example of a Special Layer: Calendar

A calendar can be generated as a Special Layer for display of a temporal visual document. This Special Layer would require a ‘start date’ and an ‘end date’, most other information regarding the nature and structure of the Calendar could be determined automatically. The thematic layers would then use the structure of the calendar as a basis for thematic treatments such as coloring and contouring.

In an example from ENTROPÍA^{vii} a calendar is shown that can be created into a spiral. The structure and layout of this spiral will be the subject of considerable design discussions by information designers focused on issues such as aesthetics and clarity of information. The result of this discussion is a visual design of a spiral calendar Special Layer. This Special Layer can then be used for thematic treatments such as coloring.

Embodiments of the present invention herein described involve systems that utilize the above described methods that have been modified and improved upon.

Embodiments of the present invention are implemented using a system adapted to perform a method, as well as a method alone, for calculating a contiguous surface from discrete data.

In summary, the system according to various embodiments of the present invention includes at least a processor, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the system may include one or more communication devices (wired or wireless) for communicating with external and internal devices, and one or more input/output devices, such as a display, pointing device, keyboard or printing device.

The processor is arranged to perform the steps of a program stored as program instructions within the memory device. The program instructions enable the various methods of performing the invention as described herein to be performed. The program instructions may be developed or implemented using any suitable software programming language and toolkit, such as, for example, a C-based language. Further, the program instructions may be stored in any suitable manner such that they can be transferred to the memory device or read by the processor, such as, for example, being stored on a computer readable medium. The computer readable medium may be any suitable medium, such as, for example, solid state memory, magnetic tape, a compact disc (CD-ROM or CD-R/W), memory card, flash memory, optical disc, magnetic disc or any other suitable computer readable medium.

The system is arranged to be in communication with external data storage systems or devices in order to retrieve the relevant data.

It will be understood that the system herein described includes one or more elements that are arranged to perform the various functions and methods as described herein. The following portion of the description is aimed at providing the reader with an example of a conceptual view of how various modules and/or engines that make up the elements of the system may be interconnected to enable the functions to be implemented. Further, the following portion of the description explains in system related detail how the steps of the herein described method may be performed. The conceptual diagrams are provided to indicate to the reader how the various data elements are processed at different stages by the various different modules and/or engines.

It will be understood that the arrangement and construction of the modules or engines may be adapted accordingly depending on system and user requirements so that various functions may be performed by different modules or engines to those described herein.

It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

The methods described herein may be implemented using a general purpose computing system specifically programmed to perform the described steps. Alternatively, the methods described herein may be implemented using a specific computer system such as a data visualization computer, a database query computer, a graphical analysis computer, a gaming data analysis computer, a manufacturing data analysis computer, a business intelligence computer etc., where the computer has been specifically adapted to perform the described steps on specific data captured from an environment associated with a particular field.

Various embodiments of how a surface (Cardno Surface) is created by the herein described system are provided. The methodologies may involve multiple applications of different order interpolation models as shown above and may optionally be modified by combining the interpolated surface with a smoothing model as described below with increasing levels of accuracy. The final surface created or generated by the system may typically be an interpolation surface that adjusts the smoothed models so that the final data passes exactly through all data points, creating a visualization that consists of minima and maxima, for example, local minima and local maxima or global minima and global maxima.

As defined in Wikipedia at http://en.wikipedia.org/wiki/Maxima_and_minima:
Maxima and minima are known collectively as extrema, and are defined as the largest value (maximum) or smallest value (minimum), that a function takes in a point either within a given neighbourhood (local extremum, e.g. local minima or local maxima) or on the function domain in its entirety (global extremum e.g. global minima or global maxima).

### First Embodiment

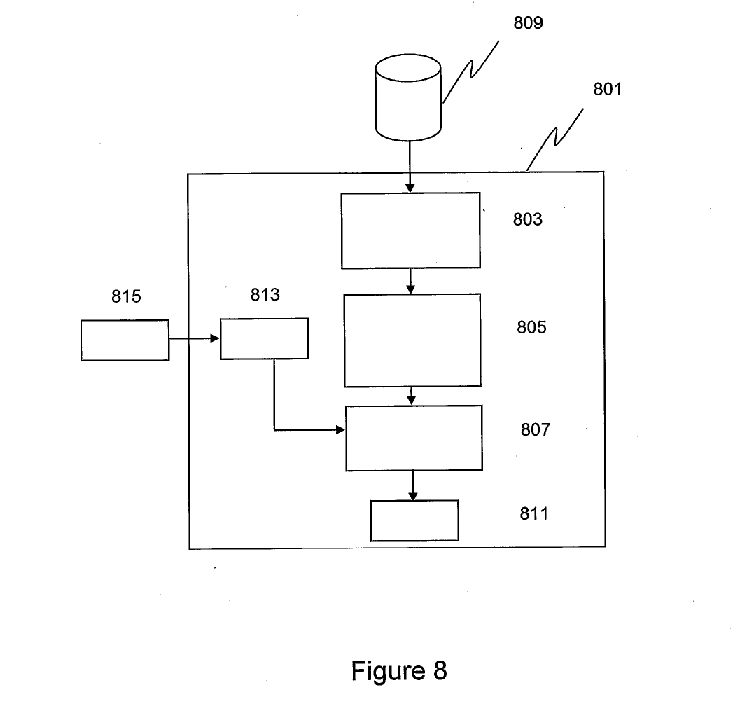

According to this embodiment there is shown in FIG. 8 a conceptual system diagram of a data visualization system 801 which includes a data retrieval module 803 configured to enable the retrieval of data from a data storage module, which is in communication with the data visualization system.

The system further includes a smoothing module 805 and an interpolation module 807 which are arranged to receive the data obtained by the retrieval module. Each of the smoothing module and interpolation modules are controlled using specific algorithms to create, from the input data, a smoothed surface and an interpolated surface respectively. The smoothed and interpolated surfaces are then combined by a surface combining module 811. The output of the surface combining module is provided to a rendering module 813, which is arranged and controlled to create the appropriate signals for the output device 815, which in this embodiment is a display module, which is used to visualize the data.

In summary, the smoothing module applies a smoothed model to input data to create smoothed surfaces, and the interpolation module applies an interpolation method to the input data to create a precise interpolated surface around the data points.

The surface combining module is used to combine the smoothed surface output from the smoothing module with the interpolated surface output from the interpolation module. The surface combining module 811 incorporates a weighting module 812 that calculates a weighted average of the output of the smoothing and interpolation functions so that the combined output creates a smooth visualization at points for which data has not been observed. The combined surface therefore shows local minima and maxima at the n given points x₁, x₂, . . . , xₙ in the 2D plane.

This combined surface enables a user of the system to visualize the overall pattern associated with the output of the smoothing module, along with the surface points that correctly pass through the source as output by the interpolation module. This therefore enables the user to see, simultaneously, in the resultant (i.e. combined) surface, both the overview and the details of the input data provided to the system.

It is important to note that, in this embodiment, the smoothed surface created by the smoothing module is generated so that it does not appear near the data points. That is, the smoothing function acts as a “weighted” mean of the data points.

Examples of how the modules of the system may create a combined surface of the smoothed and interpolated surfaces according to this embodiment are described as follows.

### Interpolation Step

The interpolating function applied by the interpolating module in this embodiment is as described in the IDW interpolation example as follows. That is, interpolation of the input data is carried out by using the following IDW method.

### Inverse Distance Weighting (IDW) Interpolation Function

The Inverse Distance Weighting (IDW) Interpolation function is a gravity function. The function works by obtaining or retrieving data that includes “n” data points (Xᵢ,Yᵢ) in 2-dimensional real space, as well as the value (variable) Vᵢ at each of these points of interest. The n points are referred to as surface points. The value V is to be calculated at a point (X,Y), which is an unknown point, and which is called the interpolation point.

The notion of distance dᵢ between two points (X,Y) and (Xᵢ, Yᵢ) is defined by the equation:

d_{p,i}=[|X−Xᵢ|^{p}+|Y−Yᵢ|^{p}]^{1/p},p≧1.

Taking p=2 gives the Euclidean distance between two points on the real plane, as follows:

d_{2,i}={square root over (X−Xᵢ)²+(Y−Yᵢ)²)}.

A set of weights Wᵢ to be used in spatial interpolation is calculated where:

Wᵢ=weight of the i-th surface point for calculating V at

$$( X , Y ) = \frac{{( 1 / {d}_{p , i} )}^{a}}{{\sum }_{j = 1}^{n} {( 1 / {d}_{p , j} )}^{a}}$$

and where a, the exponent of inverse distance (1/dₚᵢ), is a positive constant and

$${\sum }_{i = 1}^{n} {W}_{i} = 1.$$

The value of V can now be calculated from the interpolation equation:

$$V ( X , Y ) = {\sum }_{i = 1}^{n} {W}_{i} {V}_{i}$$

The common choice for the exponent a=2 is used, as this choice is computationally efficient. Therefore, the weight values Wᵢ for each point are normalized against the total of the multiplicative inverse or reciprocal of the squared distance values, i.e. the weight value is a normalized version of the reciprocal of squared distance function. That is, each weighting value Wᵢ is the (1/dᵢ)² value divided by the total of all (1/dᵢ)² values for all points.

The following describes a first IDW example of calculating V(X,Y) using the above IDW method.

In the following table, n=10 surface points are shown (Xᵢ, Yᵢ), i=1, 2, . . . , 10 with known values of the variable V, and one point (X, Y) at which V needs to be calculated. The weights are calculated using the Euclidean distance (p=2) and exponent a=2.

Therefore, the weight values gradually increase for points that are closer to the interpolation point X,Y.

The value of V at the interpolation point (X,Y) is the sum of the weighted variable values Wi×Vi in the last column (54.99) of the following table, where h=d².

| | X | Y | V | hᵢ | 1/hᵢ | Wᵢ | Wᵢ × Vᵢ |
|---|---|---|---|---|---|---|---|
| x1, y1 | 2 | 7 | 70 | 13 | 0.07692 | 0.07911 | 5.53775 |
| x2, y2 | 2 | 9 | 61 | 25 | 0.04 | 0.04113 | 2.50939 |
| x3, y3 | 3 | 1 | 47 | 20 | 0.05 | 0.05142 | 2.41683 |
| x4, y4 | 6 | 6 | 64 | 2 | 0.5 | 0.51422 | 32.9101 |
| x5, y5 | 6 | 10 | 19 | 26 | 0.03846 | 0.03955 | 0.75155 |
| x6, y6 | 7 | 1 | 0 | 20 | 0.05 | 0.05142 | 0 |
| x7, y7 | 7 | 9 | 52 | 20 | 0.05 | 0.05142 | 2.67394 |
| x8, y8 | 7 | 10 | 40 | 29 | 0.03448 | 0.03546 | 1.41853 |
| x9, y9 | 8 | 2 | 52 | 18 | 0.05555 | 0.05713 | 2.97105 |
| x10, y1 | 8 | 3 | 48 | 13 | 0.07692 | 0.07911 | 3.79731 |
| x, y | 5 | 5 | | Total | 0.97234 | 1 | 54.9864 |

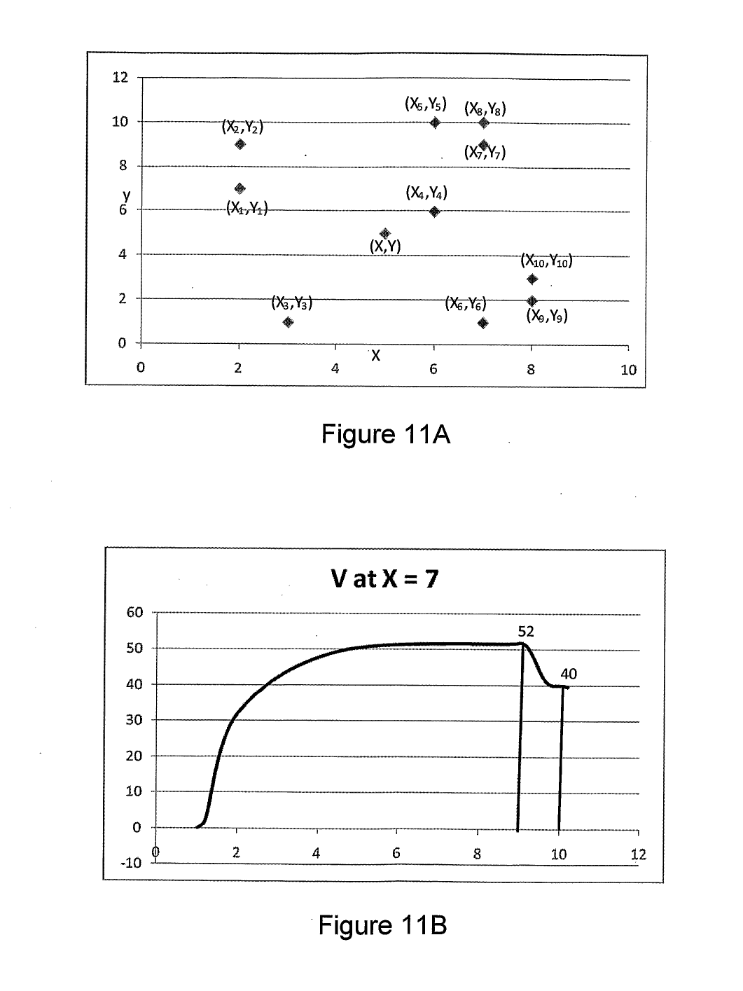

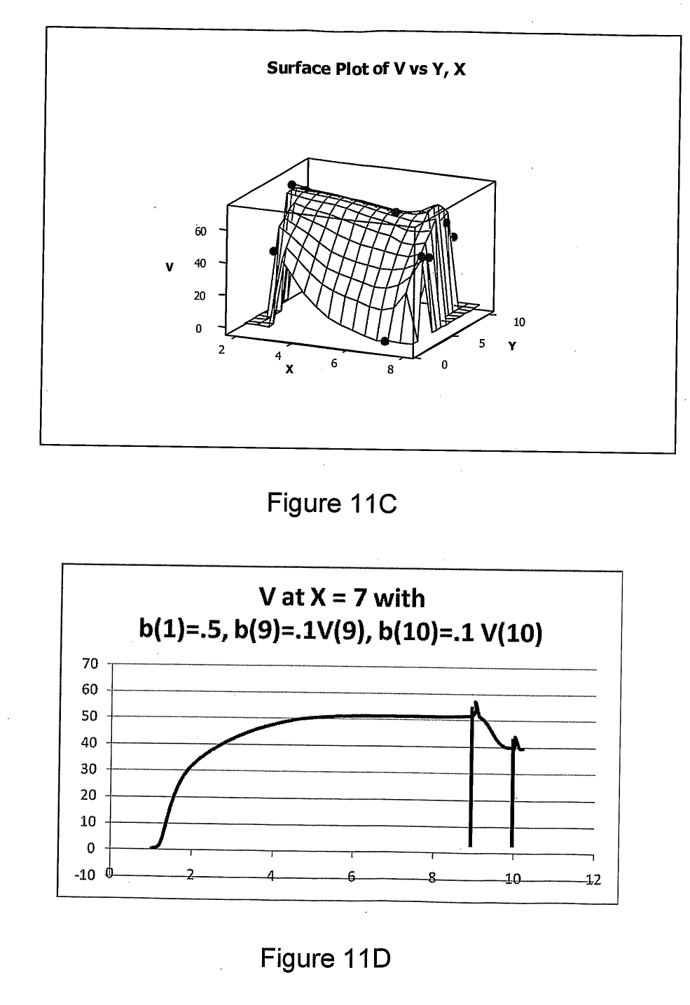

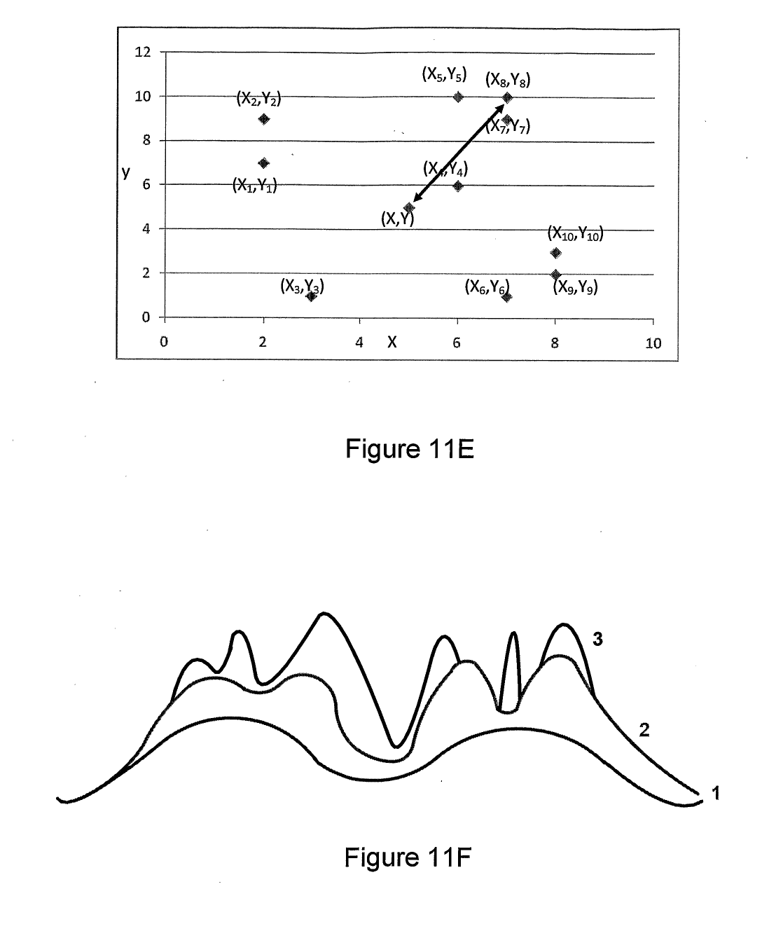

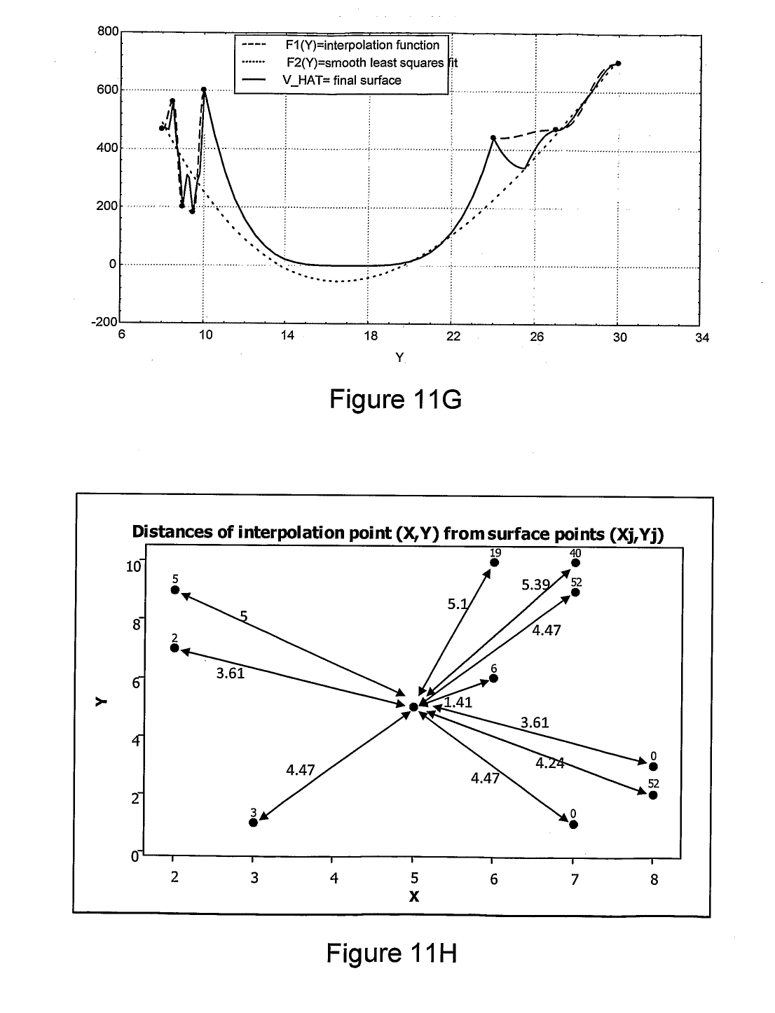

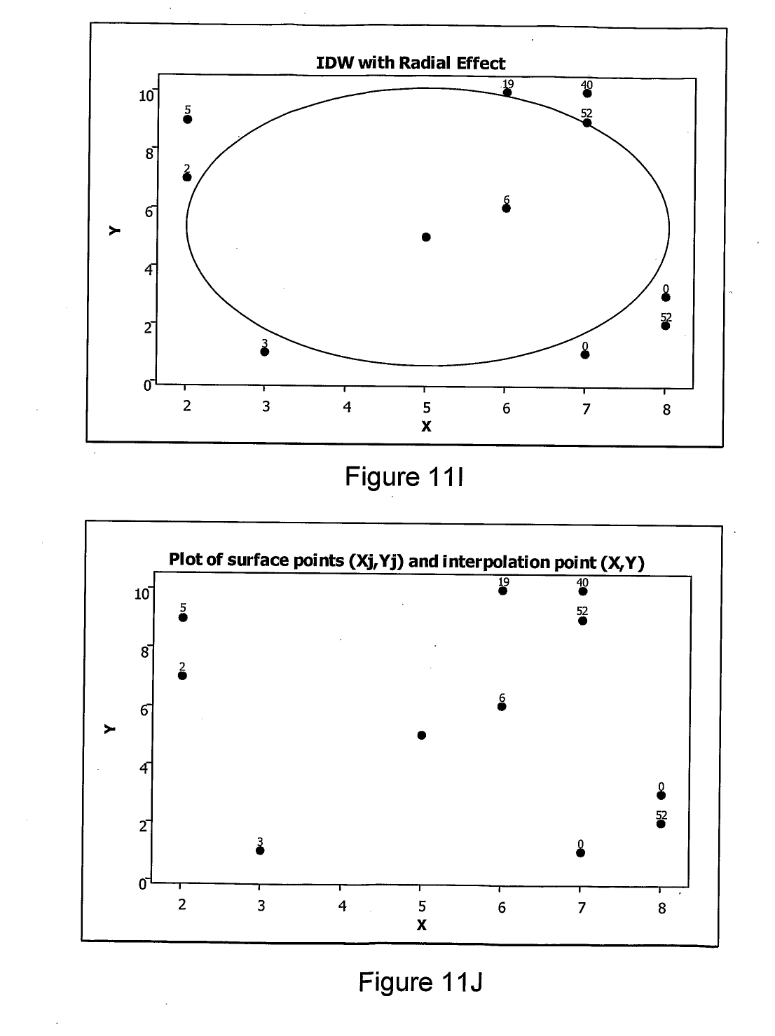

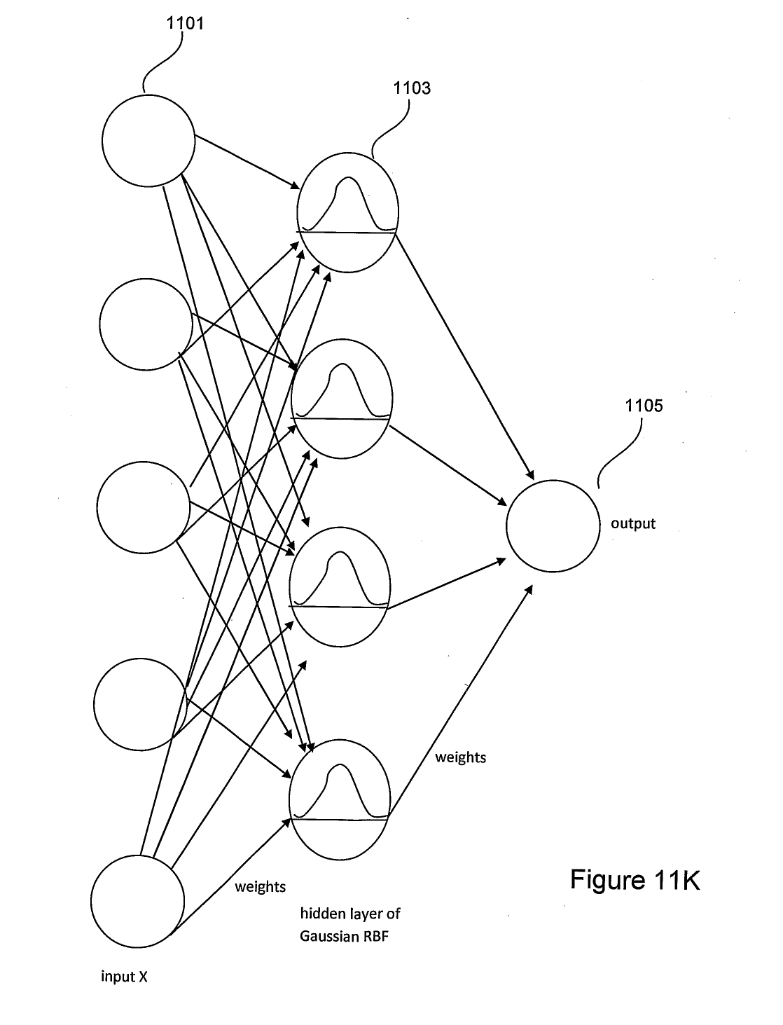

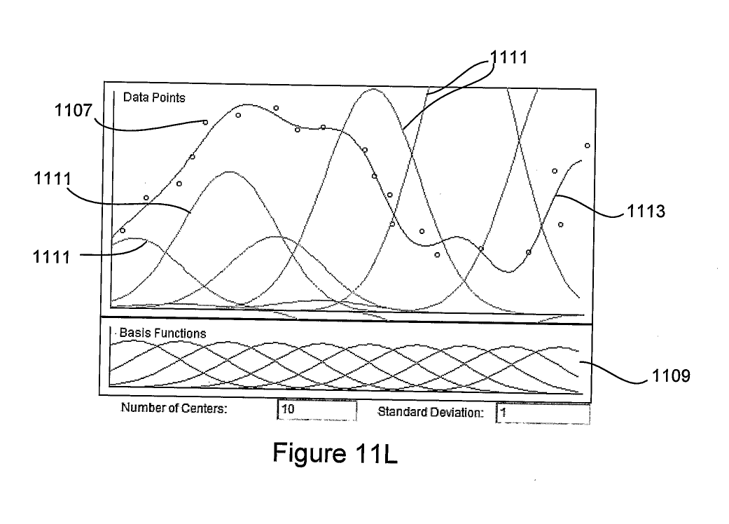

FIG. 11A shows the locations of the 10 surface points and the interpolation point (X, Y).

FIG. 11B shows the interpolated values V at a few selected points on the vertical line X=7.

FIG. 11C shows a surface plot of V vs. (X, Y).

### Tuning Constant

A tuning constant may also be included for the reasons as described herein. Note that as (X, Y)→(Xᵢ, Yᵢ) for any surface point i, the distance d_{p,i} approaches 0 and the weight Wᵢ approaches 1. In other words, the value of V at (Xᵢ, Yᵢ) calculated from the above formula will equal Vᵢ. For visualization of this invention, in order to show better resolution at each of the surface points, it is preferred to use a surface that is not interpolatory. This can be achieved by using the following weights:

$${W}_{i}^{′} = \{ \begin{matrix}1 + {b}_{i} & if {d}_{p , i} = 0 \\ \frac{{d}_{p , i}}{{\sum }_{j = 1}^{n} {d}_{p , j}} & if {d}_{p , i} \neq 0\end{matrix}$$

where bᵢ is a tuning constant.

The tuning constant may be used to calculate values at the source point only. This is because at the source point, when the distance d=0, an error would occur by causing the system to calculate a value divisible by 0. Therefore, the function is modified at the source point to make d=1 at the source point.

For example, as shown in FIG. 11D, values of V are shown where V is calculated from the modified IDW method on the vertical line X=7 (plotted vs. Y). That is, the distance d=0 at Y=1, 9 and 10 (for x=7) as can be seen in the above table at data points (x6,y6), (x7,y7) and (x8,y8). Therefore a tuning constant b has been selected to be a constant 0.5 when y=1, and a value of 0.1 xV (i.e. 10% of V) when y=9 or 10. This ensures that erroneous values are not calculated by causing the system to compute numbers divisible by 0.

### Radius Effect Example

As an alternative to the IDW example described above, a further IDW example is provided that incorporates a radius effect to calculate the weight factor as described below.

According to this example, the radius effect may be used to calculate the weight factor Wᵢ. The radius value R is calculated based on the direct radial distance to the furthest point. That is, it is calculated by determining the distance for all points by taking the square root of the sum of the squares of the x and y difference values, and using the largest of these distance values. For example, the radius value between points x,y (5,5) and x8,y8 (7,10) is the square root of (5-7)²+(5-10)²=5.385165, as shown in the table below.

The weight factor is calculated as follows using the calculated R value:

$${W}_{i} = \frac{{( \frac{R - {d}_{i}}{{Rd}_{i}} )}^{2}}{{\sum }_{j = 1}^{n} {( \frac{R - {d}_{j}}{{Rd}_{j}} )}^{2}}$$

where R=max(dᵢ)=distance between (X, Y) and the farthest point (Xᵢ, Yᵢ)

Therefore, the weight given to the furthest point is 0, whereas the weight given to points as they approach X,Y increases up to a maximum value of 1. The weight value W for each point is normalized against the total of the R_{d} column in the table below, calculated by the formula:

$${R}_{d} = {( \frac{R - {d}_{i}}{{Rd}_{i}} )}^{2} .$$

FIG. 11E shows the value R on the plot of the surface points, and shows the distance of the farthest surface point to the interpolation point.

FIG. 11H shows the distances of (X,Y) from the surface points.

FIG. 11I shows an IDW method using radial effect.

FIG. 11J shows the surface points and interpolation point (X,Y).

The value of R for the data used in the first IDW example 1 above is R=5.39 for point x8,y8. This is the maximum value in the d column for each of points x1,y1 through to x10,y10 in the following table. The calculated V at (5,5) is therefore 51.83, which is the sum of the weighted V values VW for each of the points x1,y1 through to x10,y10.

The sum of the weights is equal to one, and W is defined in the example shown as R_{d}/0.295797=W (where 0.295797=sum of R_{d})

| | X | Y | V | d | R_{d} | W | VW |
|---|---|---|---|---|---|---|---|
| x1, y1 | 2 | 7 | 70 | 3.605551 | 0.008401 | 0.0284 | 1.987992 |
| x2, y2 | 2 | 9 | 61 | 5 | 0.000205 | 0.000692 | 0.042198 |
| x3, y3 | 3 | 1 | 47 | 4.472136 | 0.001437 | 0.004859 | 0.228373 |
| x4, y4 | 6 | 6 | 64 | 1.414214 | 0.27187 | 0.91911 | 58.82306 |
| x5, y5 | 6 | 10 | 19 | 5.09902 | 0.000109 | 0.000367 | 0.006975 |
| x6, y6 | 7 | 1 | 0 | 4.472136 | 0.001437 | 0.004859 | 0 |
| x7, y7 | 7 | 9 | 52 | 4.472136 | 0.001437 | 0.004859 | 0.252668 |
| x8, y8 | 7 | 10 | 40 | 5.385165 | 0 | 0 | 0 |
| x9, y9 | 8 | 2 | 52 | 4.242641 | 0.002501 | 0.008454 | 0.439613 |
| x10, y10 | 8 | 3 | 48 | 3.605551 | 0.008401 | 0.0284 | 1.363194 |
| x, y | 5 | 5 | | Total | 0.295797 | 1 | 63.14407 |
| | | | R | 5.385165 | | | |

As an alternative, the weighting module may apply a function of the distance from the source points to the output to take into account that the surface should preferably drop off between known data points. For example, an interpolation piecewise function may be used as described in the fifth embodiment below.

As a further alternative, the system may use an adapted interpolation module that is controlled., using a Kriging algorithm (for example, see http://en.wikipedia.org/wiki/Kriging).

### Smoothing Step

According to this embodiment, the smooth approximation is implemented by the smoothing module by applying functions of increasing accuracy to the input data. The function applied to the input data is the method of least squares polynomials of increasing degrees that is applied to the input data. The output of the smoothing module is then provided to the surface combining module.

### Smoothing Alternatives

However, there may be situations where the least squares polynomials method may provide a poor fit to the data, depending on the type of data being analyzed, in which case an alternative algorithm described below may be implemented by the smoothing module by using a least squares approximation using a Radial Basis Function (RBF) Network as described below.

An RBF network (Landasse et al., 2003; Wang and Liu, 2002) with three layers (input layer 1101, a hidden layer of non-linear RBF functions 1103, and a linear output layer 1105) is shown in FIG. 11K. The RBF network looks very similar to neural networks; neural networks in fact can use radial basis functions in its hidden layer.

$$\hat{V} ( \underline{x} ) = {\sum }_{j = 1}^{m} {w}_{j} ρ ( ‖ \underline{x} - {\underline{c}}_{j} ‖ )$$

where m=number of components (neurons) in the hidden layer
cⱼ=center vector for j-th neuron
wⱼ=weight of j-th neuron in the output
∥x−cⱼ∥=Euclidean distance
ρ(.)=radial basis function
Any of the following radial basis function ρ(.) can be used in the RBF network:

φ(rⱼ)=exp(−βrⱼ²) (Gaussian)

φ(rⱼ)=\sqrt{rⱼ²+β²} (Multiquadric)

φ(rⱼ)=rⱼ² ln(rⱼ) (Thin plate spline)

where
rⱼ=∥x−cⱼ∥ and β>0 is a constant.

### Least Squares Approximation by RBF:

An RBF network may be used by the system to implement the smoothing step in the smoothing module as described below. The system controls the smoothing module to make the required calculations, as follows

As there is usually no obvious choice for centers; the width β, and the centers cⱼ are obtained first using steps 1 and 2 below, and then the weights wⱼ are determined by training the network as shown in step 3 below.

That is, the smoothing module is controlled to perform the following three steps:

Step 1) Determining the Centers cⱼ
Centers for the basis functions can be randomly generated, or cluster analysis (Johnson and Wichern, 2002) can be used on the sample points and their centroids can be used as the centers

### Step 2) Determining the Widths βⱼ

βⱼ=β=max∥cⱼ.−cⱼ.∥=maximum separation between the cluster means.
Step 3) Determining the Weights wⱼ

After the center and the widths of the basis functions are determined, the weights can be obtained from the equation

w=G⁺V where G⁺ is a pseudoinverse of G, and the n×m matrix G is given by G=(gᵢⱼ)=ρ(∥x−cⱼ∥)

An example of an output produced by the smoothing module arranged to perform least-squares approximation of a function of one variable on the data is shown in FIG. 11L. The example was created using a JAVA applet available at http://lcn.epfl.ch/tutorial/english/rbf/html/index.html.

In FIG. 11L, the blue circles 1107 are the data points to be approximated, the 10 Gaussian curves 1109 shown in the bottom panel are the Gaussian basis functions with common width 1, and 10 equally spaced centers are being used. In the top panel, the Gaussian curves 1111 shown in green are the individual Gaussian functions multiplied by their respective weights, and the red curve 1113 is the least-squares approximation using the RBF network.

The system performs the following calculations:

Given n data points (xᵢ, Vᵢ), i=1, 2, . . . , n, where x=(x₁ᵢ, x₂ᵢ) is a point in a 2D plane, compute
(a) an interpolating function for use in the interpolation module, where the function is \hat{V}₁=ƒ(x₁, x₂) that passes through the n given points. Either the IDW method or an RBF network can be used for this interpolation step.
(b) a smoothing function for use in a smoothing module, where function approximations \hat{V}₂ₖ minimize the sum of squares of errors based on the following

$$equation {\sum }_{i = 1}^{n} {( {\hat{V}}_{2 i} - {V}_{i} )}^{2} ,$$

(least squares polynomials of degrees 1, . . . k, or least squares RBF with 3, . . . , k hidden layers may be used)

It will be understood that steps a) and b) above may be implemented by the interpolating and smoothing modules at separate times or simultaneously.

(c) compute a combined surface using the surface combining module from the expression:

$$h ( \underline{x} ) = a ( \underline{x} ) {\hat{V}}_{1} + {\sum }_{all k} {b}_{k} ( \underline{x} ) {\hat{V}}_{2 k}$$

where a(x) and bₖ(x) are weights assigned to the interpolating function and the least squares approximations, respectively, with a(x)=1, and bₖ(x)=0 if x=xᵢ, i=1, 2, . . . , n, and

$$a ( \underline{x} ) + {\sum }_{all k} {b}_{k} ( \underline{x} ) = 1$$

As an alternative, a further step b2 may be applied by the smoothing module, where additional zero data points may be added to the data set to encourage the smoothing line to drop to zero when the smoothing moves away from the source points.

As a further alternative, a least squares smoothing function may be obtained by using a computer search method to estimate the coefficients of the smoothing function.

### Interpolation Alternatives

As an alternative for the interpolation step, the RBF network may also be used to implement the interpolation step in the interpolation module as described below. The system controls the interpolation module to make the required calculations, as follows.

Given n data points (xᵢ, Vᵢ), i=1, 2, . . . , n, where xᵢ=(x₁ᵢ, x₂ᵢ) is a point in 2D plane, find an interpolating function \hat{V}₁=ƒ(x₁,x₂) that passes through then given points. Taking β=1 and centers cⱼ to be the given points xⱼ=(x₁ᵢ,x₂ᵢ) the interpolating equations can be expressed as

$${V}_{i} = {\sum }_{j = 1}^{n} {w}_{j} ρ ( ‖ {x}_{- i} - {c}_{- j} ‖ ) = {\sum }_{j = 1}^{n} {w}_{j} ρ ( ‖ {x}_{- i} - {x}_{- j} ‖ ) = {\sum }_{j = 1}^{n} {w}_{j} {g}_{ij} \\ or \\ {w}_{1} {g}_{11} + {w}_{2} {g}_{12} + … + {w}_{n} {g}_{1 n} = {V}_{1} \\ {w}_{1} {g}_{21} + {w}_{2} {g}_{22} + … + {w}_{n} {g}_{2 n} = {V}_{2} \\ … \\ {w}_{1} {g}_{n 1} + {w}_{2} {g}_{n 2} + … + {w}_{n} {g}_{nm} = {V}_{n}$$

which can be expressed in matrix notation as
Gw=V, with G_{n×n}=(gᵢⱼ) is an n×n matrix and V is the n×1 column vector of V-values. The weights wⱼ can be obtained from the following equation:

w=G⁻¹V

Note: The matrix G is known to be non-singular and hence it has an inverse.

In an embodiment where the smoothing and interpolation are performed by the smoothing and interpolation modules using an RBF network, it will be understood that the modules may be combined to produced the outputs simultaneously.

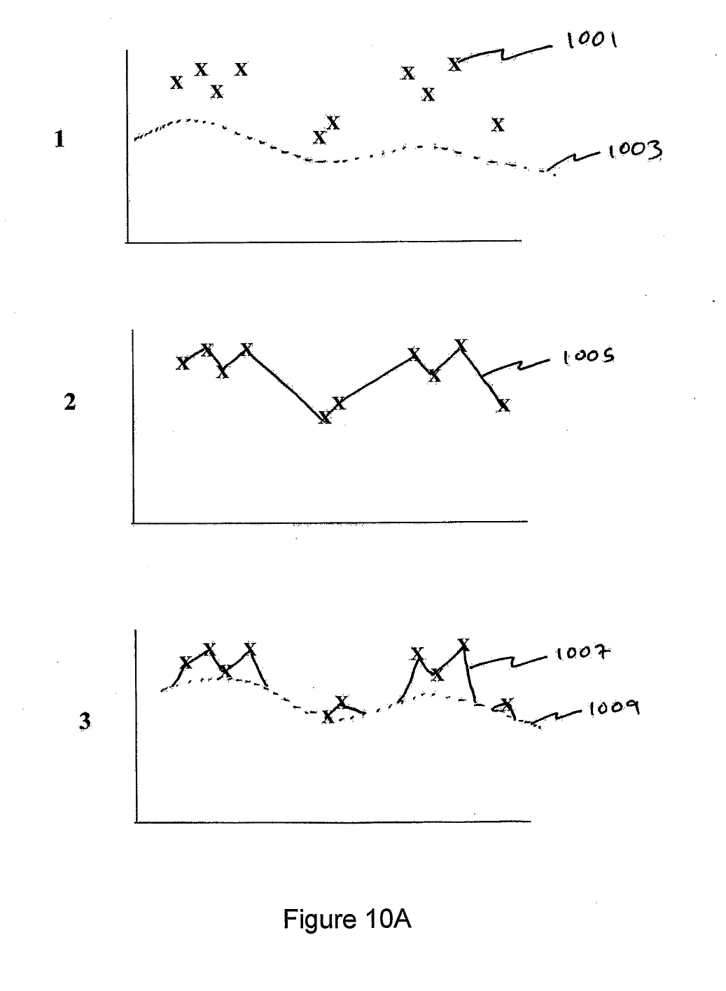

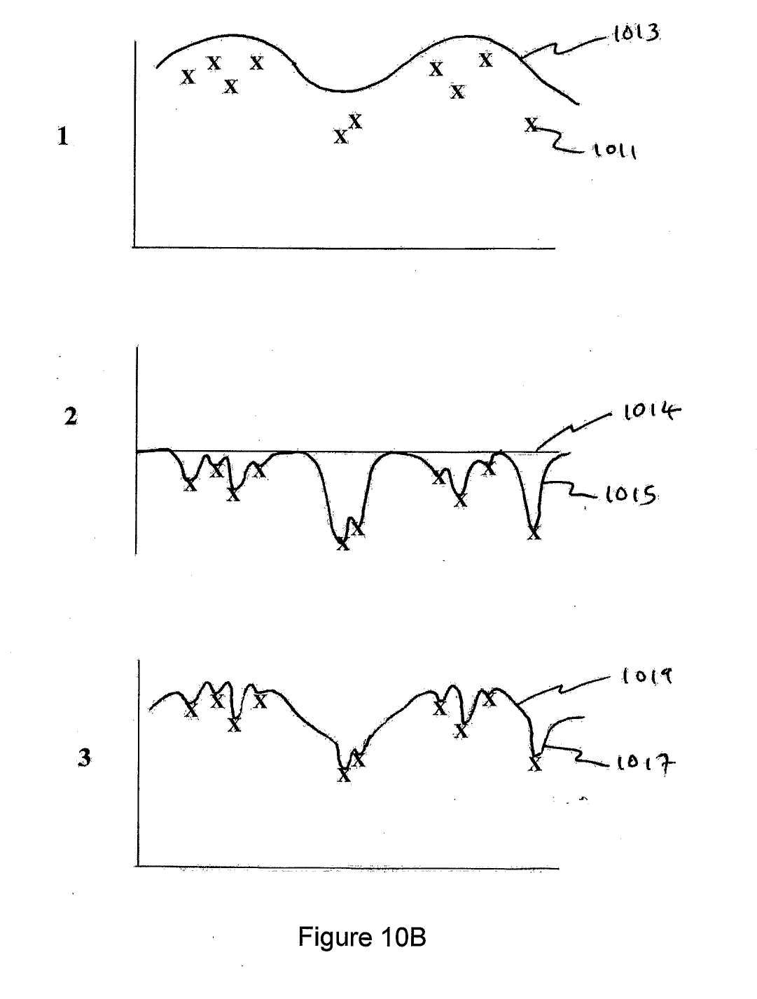

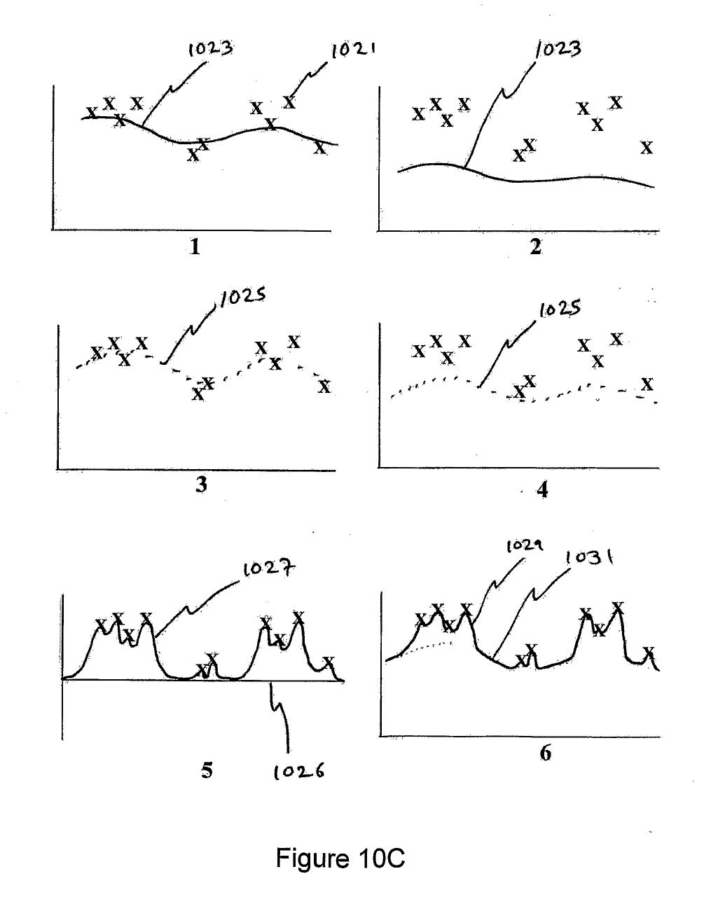

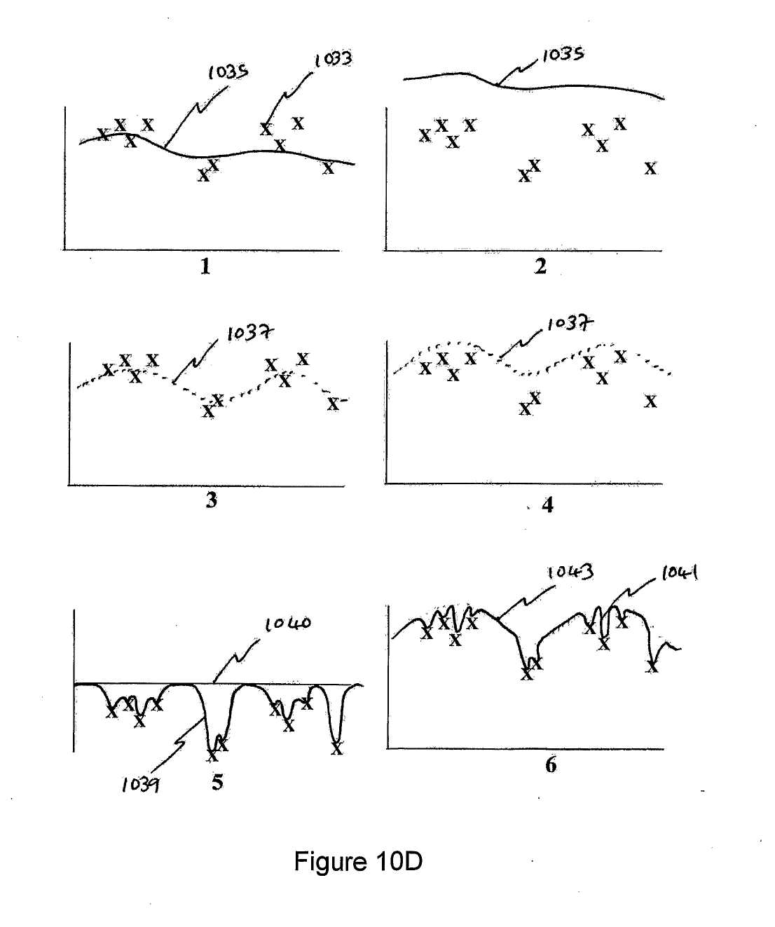

As shown in FIG. 10A, three plots (1, 2 and 3) are shown depicting graphically how the final surface is created. In plot 1, data points 1001 are located, and a smoothed line 1003 based on the data points is plotted underneath the data points.

In plot 2, an interpolated function is applied to the data points to produce the interpolated line 1005.

In plot 3, the lines 1003 and 1005 are combined or accumulated with appropriate weightings to produce a surface that shows the fine details 1007, and the general detail 1009 associated with the data points.

### Second Embodiment

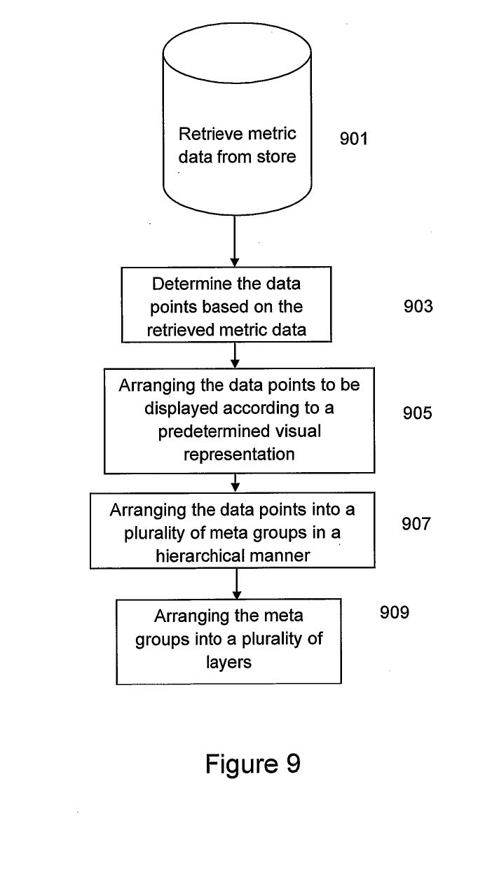

In a second embodiment, the data visualization system 8101 as shown in FIG. 9 includes a data retrieval module 8102 arranged to retrieve data from a data store 8103. Further, a surface cumulating module 8104 is controlled to produce a cumulative surface. For example, each source point has applied to it a drop off function, for example, a function that produces a conic drop off, and the surface cumulating module 8104 is arranged to combine or accumulate the drop off functions to provide a cumulative surface.

The resultant cumulative surface is then analyzed using a residual surface module 8105 to produce residuals and a residual surface.

The residuals are produced by the residual surface module 8105 by calculating the difference value between the cumulative surface output from the surface cumulating module 8104 and the actual source points. These residuals are then used by the residual surface module 8105 to generate the residual surface by applying an IDW function to the residuals.

Finally, the outputs from the residual surface module 8105 and surface cumulating module 8104 are weighted by a weighting module 8107 to produce two weighted outputs (one a weighted cumulative surface, and the other, a weighted residual surface). These two weighted surfaces are then combined using a surface combining module 8109.

The output of the surface combining module 8109 is provided to a rendering module 8111 that is arranged to render the data in any suitable required format, and forward the rendered data to an output module 8113, such as a display device or printer. The combination of these two surfaces effectively provides dimples in the cumulative surface that touch on or pass through (depending on the weighting values) the source points, to provide an overall view of the data along with a detailed view around the source points.

A further example is now provided as follows.

### Step 1

A surface is generated by the surface cumulating module using a simple cumulative function.

As an example: Function (cumulative)=(the effect of a source point)/(distance function1)

The effect of a source point here may be the sum of the surrounding source points. This creates a surface that is often above the value of the source points.

### Step 2

A secondary process is applied with distance function2 where distance function2 is typically >than distance function1. That is, distance function2 is a higher order function than distance function1. This secondary process adjusts the surface created in step 1 by creating local dimples in the surface such that the bottom of the dimple is a local minima that touches, or passes through, the source points.

Optionally, the system may include a further step before step 2 (step 1a), wherein the system thresholds the surface created by step 1 so that the surface is forced not to go above the highest source point.

Further, other decay functions or higher order functions may be used as an alternative for step 1a.

A further detailed example of how the system creates a surface according to this embodiment is now provided.

The system generates the surface as follows:
1. Create a cumulative surface using the surface cumulating module, where the surface falls above the given points by using the following expression:

$${\hat{V}}_{1} ( x , y ) = {\sum }_{all points {P}_{i} within distance r of point P} ( {w}_{i} {V}_{i} )$$

where

$${w}_{i} = \frac{{( a + dist ( P , {P}_{j} ) )}^{- 1}}{{\sum }_{j = 1}^{k} {( a + dist ( P , {P}_{j} ) )}^{- 1}}$$

a is a positive constant and dist (P,Pᵢ) is a distance function between the points P and Pᵢ.
2. Compute residuals using the residual surface module by applying the following expression eᵢ=Vᵢ−\hat{V}₁(xᵢ,yᵢ). That is, by subtracting the surface obtained in Step 1 (which falls above the known values, and hence is not an interpolating surface) from the known values Vi, the residual values are calculated. Note that all residuals will be negative.
3. Create a surface for the residuals computed in Step 2 using the residual surface module by applying the following function, as follows:

$${\hat{V}}_{2} ( x , y ) = {\sum }_{all points {P}_{i} within distance r of point P} ( {u}_{i} {e}_{i} )$$

where

$${u}_{i} = \frac{{( b + dist ( P , {P}_{i} ) )}^{- x}}{{\sum }_{j = 1}^{k} {( b + dist ( P , {P}_{j} ) )}^{- x}} ,$$

where x is a positive number, b is a positive constant, b<a, and uᵢ are another set of weights>wᵢ, so that the sum of the weights is =1.
That is, the residual surface module applies an IDW method to the residual points to create the residual surface.
4. The final surface is created by adding the residuals (weighted) from Step 3 to the surface (weighted) computed in Step 1 using the surface combining modules and weighting modules.

As shown in FIG. 10B, three plots (1, 2 and 3) are shown depicting graphically how the final surface is created. In plot 1, data points 1011 are located, and a smoothed line 1013 based on the data points is plotted above the data points.

In plot 2, an interpolated function is applied to residual points to produce the interpolated line 1015, or residual surface. That is, the line 1014 in plot 2 represents the smoothed line 1013, and the line 1015 represents the difference between the smoothed line 1013 and the data point values.

In plot 3, the lines 1013 and 1015 are combined or accumulated with appropriate weightings to produce a surface that shows the fine details 1017, and the general detail 1019 associated with the data points.

### Third Embodiment

In a third embodiment, the system generates the surface using a three step process wherein a first step includes generating a surface that has primary smoothing, a second step includes secondary smoothing adjustments in order to get a smoother surface, and a third step includes a final interpolation adjustment that makes the surface pass exactly through the data points

The first smoothing step may be calculated with a very large radius, for example (more smoothing is applied), whereas subsequent smoothing may use a smaller radius in order to show finer smoothed details. Using this process may on some datasets reduce the visual anomalies caused by varying densities in data points.

The system modules as described above and in FIG. 8 may be used to implement the following steps.

### Step 1

The smoothing module is used to apply a primary smoothing step to the input data to create a surface that is near to the source points. A function, such as a weighting function, may then be applied, using a weighting module, to the primary surface to lower the surface so that the entire surface is less than or equal to the source points.

### Step 2

This process is repeated with secondary smoothing functions where functions created a smoothed surface to reduce the difference between the surface and source points. As in the primary smoothing technique, a function such as a weighting function is applied to ensure the adjustments are below the actual surface.

### Step 3

Finally the interpolation module applies an interpolation surface to create local minima and maxima that are used to display the surface.

According to this embodiment, a surface that shows local minima and maxima is created by the system applying the following steps:

1. A smooth approximating polynomial or a smooth approximating RBF network (such as by using the method of least squares) is first obtained using the smoothing module.

2. The smooth surface of Step 1 is multiplied by a constant c1<1 so that the entire (adjusted) smooth surface is below the known points.

3. A second higher order smoothing function is applied to the surface of step 2, by applying a weighted smoothing function to the source data and the surface of the reduced surface generated in step 2. This ensures that the resultant smoothed surface is closer to the source points.

4. This smooth surface of step 3 is multiplied by a constant c2<1 so that the entire (adjusted) smooth surface is below the known points.

5. The residuals are calculated by the residual surface module by subtracting the surface obtained at Step 4 from the known points Vᵢ, and then a least squares polynomial or a least squares RBF network is fitted to these residuals to produce an interpolated surface.

6. The surface for residuals is then added back to the smooth surface obtained in Step 4 using the surface combining module and a final interpolation surface is applied using an IDW technique, for example.

As shown in FIG. 10C, six plots (1, 2, 3, 4, 5 and 6) are shown depicting graphically how the final surface is created.

In plot 1, data points 1021 are located, and a smoothed line 1023 using a first smoothing function is plotted around the data points.

In plot 2, the smoothed line 1023 is lowered below the data points.

In plot 3, a second smoothed line 1025 using a second smoothing function applied to the line 1023 is plotted.

In plot 4, the second smoothed line 1025 is lowered below the data points.

In plot 5, an interpolated function is applied to residual points to produce the interpolated line 1027, or residual surface. That is, the line 1026 in plot 5 represents the smoothed line 1025, and the line 1027 represents the difference between the smoothed line 1025 and the data point values.

In plot 6, the lines 1025 and 1026 are combined or accumulated with appropriate weightings to produce a surface that shows the fine details 1029, and the general detail 1031 associated with the data points.

### Fourth Embodiment

In a fourth embodiment the system generates the surface using similar processes to the third embodiment. However, in this embodiment, the constants applied to the smoothed surfaces are >1 so that the smoothed surfaces appear above the data points. Subsequently, the residual surface is added to the smoothed line to create dimples in the surface.

Therefore, the system applies several processes whereby in a first step a smoothing module generates a surface that has primary smoothing, a second step whereby a smoothing module generates secondary smoothing adjustments and a third step where an interpolation module makes a final interpolation adjustment using calculated residuals.

### Step 1

The primary smoothing step creates a surface that is near to the source points. The surface may be either above or below the source points

### Step 2

This process is repeated with secondary smoothing functions where functions create a smoothed surface to reduce the difference between the surface and source points.

### Step 3

Finally an interpolation surface is applied to create local minima and maxima that are used to display the surface. In this embodiment the primary and secondary surfaces may be above the source points.

In the following example of this embodiment, the system creates a surface that shows local minima and maxima using the following steps:

1. A smooth approximating polynomial or a smooth approximating RBF network (such as by using the method of least squares) is first obtained.
2. The smooth surface of Step 1 is multiplied by a constant c1>1 so that the entire (adjusted) smooth surface is above the known points.
3. A second higher order smoothing function is applied to the surface of step 2 by applying a weighted smoothing function to the source data and the surface of the reduced surface generated in step 2. This ensures that the resultant smoothed surface is closer to the source points.
4. This smooth surface of step 3 is multiplied by a constant c2>1 so that the entire (adjusted) smooth surface is above the known points
5. The residuals are calculated by subtracting the surface obtained at Step 4 from the known points Vᵢ
6 The residuals are then added back to the surface obtained in step 4 and a final interpolation surface is applied using an IDW technique, for example.

As shown in FIG. 10D, six plots (1, 2, 3, 4, 5 and 6) are shown depicting graphically how the final surface is created.

In plot 1, data points 1033 are located, and a smoothed line 1035 using a first smoothing function is plotted around the data points.

In plot 2, the smoothed line 1035 is raised above the data points.

In plot 3, a second smoothed line 1037 using a second smoothing function applied to the line 1035 is plotted.

In plot 4, the second smoothed line 1037 is raised above the data points.

In plot 5, an interpolated function is applied to residual points to produce the interpolated line 1039, or residual surface. That is, the line 1040 in plot 5 represents the smoothed line 1037, and the line 1039 represents the difference between the smoothed line 1037 and the data point values.

In plot 6, the lines 1037 and 1039 are combined or accumulated with appropriate weightings to produce a surface that shows the fine details 1041, and the general detail 1043 associated with the data points.

### Fifth Embodiment

According to this embodiment, the system uses similar modules as described with reference to FIG. 8, where the interpolation module is adapted to apply a series of gravity models and the smoothing module is adapted to smooth using a cubic process. The smoothed surface and interpolated surface are combined to yield a smooth surface that is also capable of showing local minima and maxima.

For example, the interpolation steps carried out by the interpolation module of the third and fourth embodiments above may be replaced by the interpolation module and steps described in this embodiment.

The interpolation module is adapted to implement various embodiments through the use of a combination of multiple order gravity models. In these gravity model embodiments, a series of gravity models with different P-values may be used (say P₁, P₂, . . . , Pₖ), where, as the P value increases, the order increases from low to high.

A weighted average of the resulting k surfaces is then calculated by the interpolation module to form a Composite (Cumulative) Surface made up of a combination or accumulation of multiple component surfaces. For example, as shown in FIG. 11F, three surfaces, 1, 2 and 3 from a low, to medium to high order are shown that may be combined or accumulated, using appropriate weighting, to form a cumulative resultant surface.

It will be understood that, as an alternative, an interpolated function other than weighted average may be used, such as, for example, an average or linear function.

### Gravity Model Example 1

In this example, the interpolation module implements an IDW model as the gravity model. That is, the interpolation module receives the input data from the data retrieval module, and applies a gravity model to the input data to produce the required output surface. The output of the interpolation module is forwarded to a rendering module to produce an output on an output device, in the same manner as described above.

The following portion of the description provides a first example of how the gravity model is applied using the interpolation module.

Two surfaces are produced by the interpolation module, a first surface V1 having a lower order of P=2 and the second surface V2 having a higher order of P=3. These two surfaces are combined to produce the output surface.

The terms higher and lower order are used in this description in the same sense as it is used in relation to polynomial functions, in that a higher order interpolated surface depicts a higher rate of change of the interpolated data than that of a lower order interpolated surface. For example, a lower order function may produce a line, whereas higher order functions may produce a gradient, or a rate of change of a gradient etc.

In the following example, there are 2 surfaces (k=2) that are to be combined, where the P value for surface 1, P₁, P₁,=2, and the P value for surface 2, P₂,=3; The interpolation module applies IDW weights using P₁=2 and P₂=3 as follows:

$${W}_{1 i}^{′} = \{ \begin{matrix}1 + {b}_{i} & if {d}_{2 , i} = 0 \\ \frac{{d}_{2 , i}}{{\sum }_{j = 1}^{n} {d}_{2 , j}} & if {d}_{2 , i} \neq 0\end{matrix} \\ {W}_{2 i}^{′} = \{ \begin{matrix}1 + {b}_{i} & if {d}_{3 , i} = 0 \\ \frac{{d}_{3 , i}}{{\sum }_{j = 1}^{n} {d}_{3 , j}} & if {d}_{3 , i} \neq 0\end{matrix}$$

where bᵢ is the tuning constant.

The composite IDW surface is then calculated by the interpolation module by using a weighted average of the two IDW surfaces V1 and V2 as follows:

$$V = α {\sum }_{i = 1}^{n} {W}_{1 i}^{′} {V}_{1 i} + ( 1 - α ) {\sum }_{i = 1}^{n} {W}_{2 i}^{′} {V}_{2 i}$$

where a is weight for the first surface V1 and (1−a) is the weight for the second surface V2, such that the total weight applied to the two IDW surfaces is equal to one. That is, the interpolation module produces an output surface V that is a weighted sum of a first weighted IDW surface combined with a weighted sum of a second weighted IDW surface.

It will be understood that, as an alternative, modules separate from the interpolation module may be used to apply weights and combine the surfaces, such as a surface combining module and weighting module.

### Gravity Model Example 2

A second example of how an interpolation module may be adapted to perform an alternative gravity model is now provided to show how the system may be used to produce a further example of a surface. Data used for this example is shown in the table below, where J indicates nodes 1 to 8 in a data set, X and Y indicates the axis position of each node and V indicates the value for that data point.

| J | X | Y | V |
|---|---|---|---|
| 1 | 7 | 8 | 466 |
| 2 | 7 | 8.5 | 560.375 |
| 3 | 7 | 9 | 200 |
| 4 | 7 | 9.5 | 180 |
| 5 | 7 | 10 | 600 |
| 6 | 7 | 24 | 440 |
| 7 | 7 | 27 | 470 |
| 8 | 7 | 30 | 700 |

It can be seen that, in this data set, there is a wide gap between Y=10 and Y=24. In order to compensate for this gap, i.e. to ensure that the surface produced accurately depicts the gap, an interpolation piece wise function is implemented

The interpolation piecewise function f1(Y) is used by the interpolation module as follows:

The interpolation module applies the IDW method for f1(Y) for the following values:

### 8≦Y≦10 and 24≦Y≦30.

The interpolation function f1(Y) in the range 10≦Y≦24 is selected so that it has a bathtub shape for the gravity model to indicate that there are no values V associated for Y values between 10 and 24.

The interpolation module may automatically adapt for different data sets in the input data set by detecting which portions of the data set are not associated with any values, such as the range in the above data set for Y between 10 and 24.

The interpolation function f1(Y) used in this example in the range 10≦Y≦24 is calculated as follows:

$$f 1 ( Y ) = \{ \begin{matrix}{( Y - 17 )}^{4} / 4.001666667 , & 10 \leq Y \leq 17 \\ {( Y - 17 )}^{4} / 5.456818182 , & 17 < Y \leq 24\end{matrix}$$

In this example, the value 17 has been selected by the interpolation module as it is the half way point between 10 and 24, and the function f1(Y) is being applied over two portions of the data set.

It will be understood that more steps may be applied depending on how large the data gap is in the data and how the data is apportioned.

A first constant value (4.001666667) in the function f1(Y) is calculated by inserting an end point value of Y=10 into the function and calculating a constant value that results in the equation (Y−17)⁴/cons tan t=600, where 600 is the value of V at Y=10.

A different constant value for the function f1(Y) is calculated in the same manner for the other end point where Y=24, i.e. where V=440.

For smoothing, the smoothing module produces a least squares smooth surface of the V values by fitting a cubic equation in Y to the V-values as follows.

Values for Y=11, 12, . . . , 23 are added to the data set by the smoothing module by detecting where there are missing values form the input data set. The smoothing module then applies a V value of V=0 for each of the additional data points added to the data set, i.e. where Y=11 to 23.

A least squares method is used to fit a cubic equation to the V values. For example, the following model was obtained using a statistical software package to apply a least squares method to the Y and V values:

ƒ2(Y)=2279−320Y+13.14Y²−0.1403Y³

It will be understood that the smoothing module may apply different smoothing models depending on the input data being analyzed, where the smoothing module may be automatically calculated using any suitable known statistical software package.

A weight function w(Y) as shown in the table below is calculated using a weighting module as follows:

$$w ( Y ) = \{ \begin{matrix}1 - \frac{2 ( Y - {Y}_{j} )}{( {Y}_{j + 1} - {Y}_{j} )} , & {Y}_{j} \leq Y \leq {m}_{j} \\ - 1 + \frac{2 ( Y - {Y}_{j} )}{( {Y}_{j + 1} - {Y}_{j} )} , & {m}_{j} \leq Y \leq {Y}_{j + 1}\end{matrix} , j = 1 , 2 , 3 , 4 , 6 , 7 , 8$$

where

$${m}_{j} = \frac{{Y}_{j} + {Y}_{j + 1}}{2}$$

is the middle point of the interval [Yⱼ, Yᵢ₊₁].

Here Y₁=8, Y₂=8.5, Y₃=9, . . . , Y₇=27, Y₈=20.

That is, the weight function w(Y) is chosen so as to put more weight on f1(Y) near the above 8 nodes (J=1 to 8), and less weight on the smooth function f2(Y). The weight function inside the interval [10, 24], i.e., for j=5, is 1.

The final surface V_hat is calculated by combining or accumulating the two surfaces f1(Y) and f2(Y) using a surface combining module where:

V_hat=w(Y)ƒ1(Y)+[1−w(Y)]ƒ2(Y).

That is, the final surface output by the interpolation module is a sum of the weighted functions f1(Y) and f2(Y), where f1(Y) is a piecewise interpolated function adapted to operate over different portions of the data set based on the data values in those portions, and f2(Y) is a smoothing function applied to the data points.

The following table shows values calculated using the above processes.

| Y | f1 (y) | f2 (y) | w (Y) | V_hat |
|---|---|---|---|---|
| 8 | 466 | 488.1264 | 1 | 466 |
| 8.1 | 471.5515 | 474.5542 | 0.6 | 472.7526 |
| 8.2 | 495.0385 | 461.1767 | 0.2 | 467.949 |
| 8.3 | 531.3365 | 447.9929 | 0.2 | 464.6616 |
| 8.4 | 554.8235 | 435.002 | 0.6 | 506.8949 |
| 8.5 | 560.375 | 422.2033 | 1 | 560.375 |
| 8.6 | 539.1765 | 409.5957 | 0.6 | 487.3442 |
| 8.7 | 449.4904 | 397.1786 | 0.2 | 407.641 |
| 8.8 | 310.8846 | 384.9511 | 0.2 | 370.1378 |
| 8.9 | 221.1985 | 372.9122 | 0.6 | 281.884 |
| 9 | 200 | 361.0613 | 1 | 200 |
| 9.1 | 198.8235 | 349.3974 | 0.6 | 259.0531 |
| 9.2 | 193.8462 | 337.9197 | 0.2 | 309.105 |
| 9.3 | 186.1538 | 326.6273 | 0.2 | 298.5326 |
| 9.4 | 181.1765 | 315.5195 | 0.6 | 234.9137 |
| 9.5 | 180 | 304.5953 | 1 | 180 |
| 9.6 | 204.7059 | 293.8539 | 0.6 | 240.3651 |
| 9.7 | 309.2308 | 283.2946 | 0.2 | 288.4818 |
| 9.8 | 470.7692 | 272.9164 | 0.2 | 312.4869 |
| 9.9 | 575.2941 | 262.7185 | 0.6 | 450.2639 |
| 10 | 600 | 252.7 | 1 | 600 |
| 10.5 | 446.0798 | 205.2702 | 1 | 446.0798 |
| 11 | 323.8651 | 162.2007 | 1 | 323.8651 |
| 11.5 | 228.6703 | 123.3862 | 1 | 228.6703 |
| 12 | 156.1849 | 88.7216 | 1 | 156.1849 |
| 12.5 | 102.4729 | 58.10156 | 1 | 102.4729 |
| 13 | 63.97334 | 31.4209 | 1 | 63.97334 |
| 13.5 | 37.5 | 8.574388 | 1 | 37.5 |
| 14 | 20.24157 | −10.5432 | 1 | 20.24157 |
| 14.5 | 9.761558 | −26.0371 | 1 | 9.761558 |
| 15 | 3.998334 | −38.0125 | 1 | 3.998334 |
| 15.5 | 1.265098 | −46.5747 | 1 | 1.265098 |
| 16 | 0.249896 | −51.8288 | 1 | 0.249896 |
| 16.5 | 0.015618 | −53.8801 | 1 | 0.015618 |
| 17 | 0 | −52.8339 | 1 | 0 |
| 17.5 | 0.011454 | −48.7953 | 1 | 0.011454 |
| 18 | 0.183257 | −41.8696 | 1 | 0.183257 |
| 18.5 | 0.927738 | −32.162 | 1 | 0.927738 |
| 19 | 2.932112 | −19.7777 | 1 | 2.932112 |
| 19.5 | 7.158476 | −4.82196 | 1 | 7.158476 |
| 20 | 14.84382 | 12.6 | 1 | 14.84382 |
| 20.5 | 27.5 | 32.38296 | 1 | 27.5 |
| 21 | 46.91379 | 54.4217 | 1 | 46.91379 |
| 21.5 | 75.14681 | 78.61099 | 1 | 75.14681 |
| 22 | 114.5356 | 104.8456 | 1 | 114.5356 |
| 22.5 | 167.6916 | 133.0203 | 1 | 167.6916 |
| 23 | 237.501 | 163.0299 | 1 | 237.501 |
| 23.5 | 327.1252 | 194.7691 | 1 | 327.1252 |
| 24 | 440 | 228.1328 | 1 | 440 |
| 24.1 | 440.0356 | 234.9912 | 0.933333 | 426.366 |
| 24.2 | 440.1523 | 241.9095 | 0.866667 | 413.7199 |
| 24.3 | 440.3659 | 248.8869 | 0.8 | 402.0701 |
| 24.4 | 440.6936 | 255.9226 | 0.733333 | 391.4214 |
| 24.5 | 441.1538 | 263.0157 | 0.666667 | 381.7745 |
| 24.6 | 441.7647 | 270.1653 | 0.6 | 373.1249 |
| 24.7 | 442.5433 | 277.3706 | 0.533333 | 365.4627 |
| 24.8 | 443.5036 | 284.6308 | 0.466667 | 358.7715 |
| 24.9 | 444.6552 | 291.9451 | 0.4 | 353.0291 |
| 25 | 446 | 299.3125 | 0.333333 | 348.2083 |
| 25.1 | 447.5311 | 306.7323 | 0.266667 | 344.2786 |
| 25.2 | 449.2308 | 314.2036 | 0.2 | 341.209 |
| 25.3 | 451.0699 | 321.7255 | 0.133333 | 338.9714 |
| 25.4 | 453.0088 | 329.2973 | 0.066667 | 337.5448 |
| 25.5 | 455 | 336.9181 | 0 | 336.9181 |
| 25.6 | 456.9912 | 344.587 | 0.066667 | 352.0806 |
| 25.7 | 458.9301 | 352.3032 | 0.133333 | 366.5201 |
| 25.8 | 460.7692 | 360.0659 | 0.2 | 380.2065 |
| 25.9 | 462.4689 | 367.8741 | 0.266667 | 393.0994 |
| 26 | 464 | 375.7272 | 0.333333 | 405.1515 |
| 26.1 | 465.3448 | 383.6242 | 0.4 | 416.3124 |
| 26.2 | 466.4964 | 391.5643 | 0.466667 | 426.5326 |
| 26.3 | 467.4567 | 399.5466 | 0.533333 | 435.7653 |
| 26.4 | 468.2353 | 407.5703 | 0.6 | 443.9693 |
| 26.5 | 468.8462 | 415.6346 | 0.666667 | 451.109 |
| 26.6 | 469.3064 | 423.7386 | 0.733333 | 457.155 |
| 26.7 | 469.6341 | 431.8815 | 0.8 | 462.0836 |
| 26.8 | 469.8477 | 440.0625 | 0.866667 | 465.8763 |
| 26.9 | 469.9644 | 448.2806 | 0.933333 | 468.5188 |
| 27 | 470 | 456.5351 | 1 | 470 |
| 27.1 | 470.2732 | 464.8251 | 0.933333 | 469.91 |
| 27.2 | 471.1675 | 473.1498 | 0.866667 | 471.4318 |
| 27.3 | 472.8049 | 481.5083 | 0.8 | 474.5456 |
| 27.4 | 475.3179 | 489.8998 | 0.733333 | 479.2064 |
| 27.5 | 478.8462 | 498.3234 | 0.666667 | 485.3386 |
| 27.6 | 483.5294 | 506.7784 | 0.6 | 492.829 |
| 27.7 | 489.4983 | 515.2638 | 0.533333 | 501.5222 |
| 27.8 | 496.8613 | 523.7788 | 0.466667 | 511.2173 |
| 27.9 | 505.6897 | 532.3226 | 0.4 | 521.6695 |
| 28 | 516 | 540.8944 | 0.333333 | 532.5963 |
| 28.1 | 527.7386 | 549.4932 | 0.266667 | 543.692 |
| 28.2 | 540.7692 | 558.1183 | 0.2 | 554.6485 |
| 28.3 | 554.869 | 566.7689 | 0.133333 | 565.1822 |
| 28.4 | 569.7345 | 575.4439 | 0.066667 | 575.0633 |
| 28.5 | 585 | 584.1428 | 0 | 584.1428 |
| 28.6 | 600.2655 | 592.8645 | 0.066667 | 593.3579 |
| 28.7 | 615.131 | 601.6082 | 0.133333 | 603.4112 |
| 28.8 | 629.2308 | 610.3732 | 0.2 | 614.1447 |
| 28.9 | 642.2614 | 619.1585 | 0.266667 | 625.3193 |
| 29 | 654 | 627.9633 | 0.333333 | 636.6422 |
| 29.1 | 664.3103 | 636.7868 | 0.4 | 647.7962 |
| 29.2 | 673.1387 | 645.6282 | 0.466667 | 658.4664 |
| 29.3 | 680.5017 | 654.4865 | 0.533333 | 668.3613 |
| 29.4 | 686.4706 | 663.361 | 0.6 | 677.2267 |
| 29.5 | 691.1538 | 672.2508 | 0.666667 | 684.8528 |
| 29.6 | 694.6821 | 681.1551 | 0.733333 | 691.0749 |
| 29.7 | 697.1951 | 690.073 | 0.8 | 695.7707 |
| 29.8 | 698.8325 | 699.0036 | 0.866667 | 698.8553 |
| 29.9 | 699.7268 | 707.9463 | 0.933333 | 700.2748 |
| 30 | 700 | 716.9 | 1 | 700 |

FIG. 11G shows a plot of the values of f1(Y), f2(Y), and V_hat calculated in the above table for points on the vertical line X=7.

It will be understood that, as an alternative, gravity models may be applied to the input data using other functions. For example, a series of gravity models may be applied and a weighted average may then taken to obtain the final surface.

In one further example, a gravity model using Lₚ, Manhattan and Chebychev Distances is provided as follows:

Given n points (Pᵢ=(x₁, yᵢ) and the value of some function Vᵢ, i=1, 2, . . . , n gravity models for the value of V at an unsampled point P=(x, y) can be created by the following equations:

$${\hat{V}}_{p} ( x , y ) = {\sum }_{i = 1}^{n} {w}_{p 1 i} {V}_{i} , {w}_{1 i} = \frac{{( {d}_{p} ( P , {P}_{i} ) )}^{- 1}}{{\sum }_{i = 1}^{n} {( {d}_{p} ( P , {P}_{i} ) )}^{- 1}} , p = 2 , 3 , 4 , …$$

$${\hat{V}}_{1} ( x , y ) = {\sum }_{i = 1}^{n} {w}_{11 i} {V}_{i} , {w}_{1 i} = \frac{{( {d}_{1} ( P , {P}_{i} ) )}^{- 1}}{{\sum }_{i = 1}^{n} {( {d}_{1} ( P , {P}_{i} ) )}^{- 1}}$$

$${\hat{V}}_{∞} ( x , y ) = {\sum }_{i = 1}^{n} {w}_{∞1 i} {V}_{i} , {w}_{1 i} = \frac{{( {d}_{∞} ( P , {P}_{i} ) )}^{- 1}}{{\sum }_{i = 1}^{n} {( {d}_{∞} ( P , {P}_{i} ) )}^{- 1}}$$

Two different composite surface models may then be computed, for example, by using the following algorithms applied to the modules:

$$\hat{V} ( x , y ) = {\sum }_{p = 2}^{4} {α}_{p} {\hat{V}}_{p} ( x , y ) , {α}_{p} = 1 / 3 ,$$

composite surface using Lₚ distances for p=2, 3, 4. \hat{V}(x,y)=0.5\hat{V}₁(x, y)+0.5\hat{V}₂(x, y), composite surface using L₁ and L_{∞} distances

It can be seen that the various embodiments described herein may be used to solve various technical problems within a number of different industries.

For example, within a manufacturing environment that contains several work processes in different manufacturing lines, measurement data may be obtained from these processes that depicts the quality of the products being produced. For example, automatic testing procedures may be in place that analyse products being manufactured to see if they conform to the quality standards that the manufacturer adheres to. For example, the testing may be by way of making specific measurements on a physical product (for example. measuring the dimensions of a precise engineering product in use in a car engine), or measuring the output of a product (for example, the output of produced LEDs).

This measurement data may be used to determine a quality value associated with the manufactured products, where the quality value can be, for example, associated with specific product lines, specific manufacturing areas in a manufacturing environment, specific factories, regions or countries etc.

Embodiments of the herein described system enable a graphical visualization to be produced that can not only show the quality values for individual products at specific times, but also a general overall quality value for a whole manufacturing environment. This enables a user to see how well different individual aspects of the manufacturing environment are doing within the environment as a whole (for example, if certain work stations or areas in the factory are producing lower or higher quality products than average), as well as the overall picture of how well the whole environment is performing.

These results may be fed back into the manufacturing systems either automatically or manually to adjust how the systems operate to compensate for any consistent detected errors.

Therefore, the data visualization techniques described herein transform the raw data received into a visual arrangement that enables further or hidden information within the raw data to be visually represented in a manner that conveys the information to a user in an efficient manner.

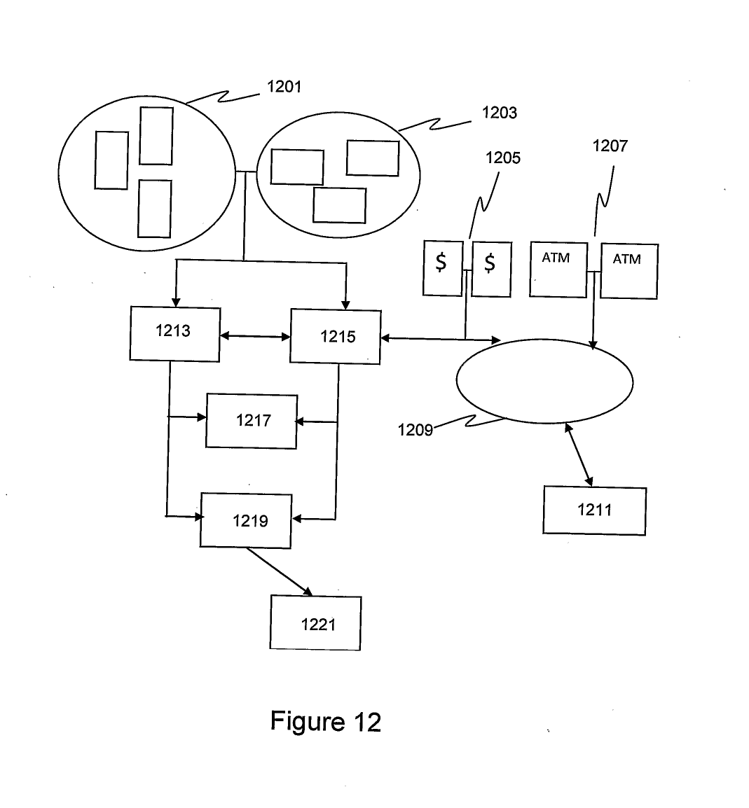

FIG. 12 shows an example of how the herein described system may be incorporated within a gaming environment. The gaming environment consists of a number of gaming machines 1201 and electronic tables 1203 (among other electronic gaming devices) that are adapted to communicate electronically with other systems using any suitable protocols, such as data packet protocols.

The gaming environment further includes a number of electronic cashier devices 1205 and ATMs 1207 which are in communication via a Wide Area Network 1209 with one or more financial databases 1211.

Data from the gaming machines 1201 and electronic tables 1203 are transferred to a reward program database 1213 and customer database 1215. It will be understood that these two databases may be combined into a single database.

Data from the cashier devices are also transferred to the reward program database 1213 and customer database 1215. The databases 1213 and 1215 are in communication with a central hotel management system 1217 that oversees the operation of the gaming environment, including the activities of customers in other areas of a casino, such as shops, hotels, spas etc.

The system 1219 described herein is in communication with the reward program database 1213, customer database 1215 and central hotel management system 1217 so the system can retrieve all necessary data about the activities within the gaming environment. The various embodiments as described herein are employed by the system 1219 to provide an output 1221.

### GLOSSARY

| Term | Definition |
|---|---|
| Agile | Agile software development is a conceptual framework |
| Development | for software engineering that promotes development |
| | iterations throughout the life-cycle of the project. |
| | There are many agile development methods; most |
| | minimize risk by developing software in short amounts |
| | of time. Software developed during one unit of time is |
| | referred to as an iteration, which may last from one to |
| | four weeks. Each iteration is an entire software project: |
| | including planning, requirements analysis, design, |
| | coding,testing, and documentation. An iteration may not |
| | add enough functionality to warrant releasing the product |
| | to market but the goal is to have an available release |
| | (without bugs) at the end of each iteration. At the end of |
| | each iteration, the team re-evaluates project priorities. |
| | Wikipedia^{viii} |
| BPD Packages | A BPD Package is made up from a set of related BPDs. |
| | This relationship (between a BPD Package and its BPDs) |
| | is defined using metadata. |
| | BPD Packages can be thought of as the Visual |
| | Document's vocabulary. |
| Catalog | The described catalog is used to store permanent and |
| | temporary objects that are necessary for creation and |
| | storage of Visual Documents. These may include Visual |
| | Designs, BPDs, Configuration tools and other objects. |
| | There may be multiple catalogs of different types |
| | (such as database, flat file) which are configured by |
| | an integrator dependent on customer requirements. |
| | All items in a catalog are identified by a unique ID and |
| | can only be accessed by those with the correct |
| | authorization. |
| Data Packages | Data Packages contain data that can be sold with |
| | subscription or service provision including an associated |
| | managed dataset. For example, census data will be |
| | available as a Data Package; this Data Package will |
| | enable the described solution users to interact and use a |
| | slowly changing dataset called census. (Census data can |
| | be updated after each census and is often modeled |
| | between each census). |
| Dimension | Dimensional modeling always uses the concepts of facts |
| | (sometimes referred to as measures) and dimensions. |
| | Facts are typically (but not always) numeric values that |
| | can be aggregated, and dimensions are groups of |
| | hierarchies and descriptors that define the facts. For |
| | example, sales amount is a fact; timestamp, product, |
| | register#, store#, etc. are elements of dimensions. |
| | Wikipedia^{ix} |
| Dimensional | DM is a logical design technique that seeks to present the |
| Modeling | data in a standard, intuitive framework that allows for |
| | high-performance access. It is inherently dimensional, |
| | and it adheres to a discipline that uses the relational |
| | model with some important restrictions. Every |
| | dimensional model is composed of one table with a |
| | multipart key, called the fact (sometimes referred to as |
| | measures) table, and a set of smaller tables called |
| | dimension tables. Each dimension table has a single-part |
| | primary key that corresponds exactly to one of the |
| | components of the multipart key in the fact table. |
| | Intelligent Enterprise^{x} |
| Enterprise Java | In a typical J2EE application, Enterprise JavaBeans |
| Beans (EJBs) | (EJBs) contain the application's business logic and live |
| | business data. Although it is possible to use standard Java |
| | objects to contain your business logic and business data, |
| | using EJBs addresses many of the issues you would find |
| | by using simple Java objects, such as scalability, |
| | lifecycle management, and state management. |
| | Wikipedia^{xi} |
| Fact | Dimensional modeling always uses the concepts of facts |
| | (sometimes referred to as measures) and dimensions. |
| | Facts are typically (but not always) numeric values that |
| | can be aggregated, and dimensions are groups of |
| | hierarchies and descriptors that define the facts. For |
| | example, sales amount is a fact; timestamp, product, |
| | register#, store#, etc. are elements of dimensions. |
| | Wikipedia^{xii} |
| IIOP (Internet | IIOP (Internet Inter-ORB Protocol) is a protocol that |
| Inter-ORB | makes it possible for distributed programs written in |
| Protocol) | different programming languages to communicate over |
| | the Internet. SearchCIO - Midmarket^{xiii} |
| KML | Keyhole Markup Language. |
| | Google ™ Earth is a geographic browser - a powerful |
| | tool for viewing, creating and sharing interactive files |
| | containing highly visual location-specific information. |
| | These files are called KMLs (for Keyhole Markup |
| | Language): what HTML is to regular Internet |
| | browsers,KML is to geographic browsers. You can open |
| | KML files in both Google ™ Earth and Google ™ Maps, |
| | as well as in many other geographic browsers. |
| | Google ™ Maps^{xiv} |
| MDT | The average time that a system is non-operational. This |
| | includes all time associated with repair, corrective and |
| | preventive maintenance; self imposed downtime, and any |
| | logistics or administrative delays. The difference between |
| | MDT and MTTR (mean time to repair) is that MDT |
| | includes any and all delays involved; MTTR looks solely |
| | at repair time. Wikipedia^{xv} |
| Metadata | Metadata describes how data is queried, filtered, |
| | analyzed, and displayed in the described solution. In |
| | general terms, metadata is data about data. For example, |
| | in a library the metadata (pertaining to the catalog of |
| | books) could be - the title of the book, the author(s), |
| | categories (e.g. reference, fiction, non-fiction etc), |
| | physical location. This metadata can be used in searches, |
| | directories etc to help users locate books. |
| MTBF | Mean time between failures (MTBF) is the mean |
| | (average) time between failures of a system, and is often |
| | attributed to the ‘useful life’ of the device |
| | i.e. not including ‘infant mortality’ or ‘end of life’. |
| | Calculations of MTBF assume that a system is |
| | ‘renewed’, i.e. fixed, after each failure, and then |
| | returned to service immediately after failure. The average |
| | time between failing and being returned to service is |
| | termed mean down time (MDT) or mean time to |
| | repair (MTTR). |
| | MTBF = (downtime − uptime)/number of failures. |
| | Wikipedia^{xvi} |
| MTTR | Mean Time to Recovery - the average time that a device |
| | will take to recover from a non-terminal failure. |
| | Examples of such devices range from self-resetting fuses |
| | (where the MTTR would be very short, probably |
| | seconds), up to whole systems which have to be replaced. |
| | The MTTR would usually be part of a maintenance |
| | contract, where the user would pay more for a system |
| | whose MTTR was 24 hours, than for one of, say, 7 days. |
| | This does not mean the supplier is guaranteeing to have |
| | the system up and running again within 24 hours (or 7 |
| | days) of being notified of the failure. It does mean the |
| | average repair time will tend towards 24 hours (or 7 |
| | days). A more useful maintenance contract measure is the |
| | maximum time to recovery which can be easily measured |
| | and the supplier held accountable. Wikipedia^{xvii} |
| OLAP | On Line Analytical Processing. |
| | OLAP performs multidimensional analysis of business |
| | data and provides the capability for complex calculations, |
| | trend analysis, and sophisticated data modeling. |
| | OLAP enables end-users to perform ad hoc analysis of |
| | data in multiple dimensions, thereby providing the insight |
| | and understanding the need for better decision making. |
| | Paris ™ Technologies^{xviii} |
| Planogram | A planogram is a diagram of fixtures and products that |
| | illustrates how and where retail products should be |
| | displayed, usually on a store shelf in order to increase |
| | customer purchases. They may also be referred to as |
| | planograms, plan-o-grams, schematics (archaic) or POGs. |
| | A planogram is often received before a product reaches a |
| | store, and is useful when a retailer wants multiple store |
| | displays to have the same look and feel. Often a |
| | consumer packaged goods manufacturer will release |
| | a new suggested planogram with their new product, |
| | to show how it relates to existing products in said |
| | category. Planograms are used nowadays in all kind of |
| | retail areas. A planogram defines which product is |
| | placed in which area of a shelving unit and with which |
| | quantity. The rules and theories for the creation of a |
| | planogram are set under the term of merchandising. |
| | Wikipedia^{xix} |
| Request Queue | The Request Queue manages Visual Documents requests |
| | generated by a user or the scheduler. |
| | As requests are processed, the Visual Document |
| | maintains various statuses until the Visual Document is |
| | complete and available to be viewed by a user. |
| SaaS | Software as a Service. |
| | A software application delivery model where a software |
| | vendor develops a web-native software application and |
| | hosts and operates (either independently or through a |
| | third-party) the application for use by its customers over |
| | the Internet. Customers do not pay for owning the |
| | software itself but rather for using it. Wikipedia^{xx} |
| Scrum | Scrum is an agile process that can be used to manage and |
| | control software development. |
| | With Scrum, projects progress via a series of iterations |
| | called sprints. These iterations could be as short as 1 |
| | week or as long as 1 month. |
| | Scrum is ideally suited for projects with rapidly changing |
| | or highly emergent requirements. The work to be done on |
| | a Scrum project is listed in the Product Backlog, which is |
| | a list of all desired changes to the product. At the start of |
| | each sprint a Sprint Planning Meeting is held during |
| | which the Product Owner prioritizes the Product Backlog |
| | and the Scrum Team selects the tasks they can complete |
| | during the coming Sprint. These tasks are then moved |
| | from the Product Backlog to the Sprint Backlog. |
| | Each day during the sprint a brief daily meeting is held |
| | called the Daily Scrum, which helps the team stay on |
| | track. |
| | At the end of each sprint the team demonstrates the |
| | completed functionality at a Sprint Review Meeting. |
| Self Organizing | A type of artificial neural network that is trained using |
| Maps (SOM) | unsupervised learning to produce a low-dimensional |
| | (typically two dimensional), representation of the input |
| | space of the training samples, called a map. The map |
| | seeks to preserve the topological properties of the input |
| | space. Wikipedia^{xxi} |
| Servlets | Servlets are modules of Java code that run in a server |
| | application (hence the name “Servlets”, similar to |
| | “Applets” on the client side) to answer client requests. |
| | Servlets are not tied to a specific client-server protocol |
| | but they are most commonly used with HTTP and the |
| | word “Servlet” is often used in the meaning of “HTTP |
| | Servlet”. |
| | Servlets make use of the Java standard extension classes. |
| | Since Servlets are written in the highly portable Java |
| | language and follow a standard framework, they provide |
| | a means to create sophisticated server extensions in a |
| | server and operating system independent way. |
| | Typical uses for HTTP Servlets include: |
| | 1. Processing and/or storing data submitted by an |
| | HTML form. |
| | 2. Providing dynamic content, e.g. returning the results |
| | of a database query to the client. |
| | 3. Managing state information on top of the stateless |
| | HTTP, e.g. for an online shopping cart system which |
| | manages shopping carts for many concurrent |
| | customers and maps every request to the right |
| | customer. |
| | Servlet Essentials^{xxii} |
| Subject Matter | The Subject Matter Expert is that individual who exhibits |
| Expert (SME) | the highest level of expertise in performing a specialized |
| | job, task, or skill within the organization. Six Sigma^{xxiii} |
| WebSphere | WebSphere is an IBM ™ brand of products that |
| | implement and extend Sun's JavaTwoEnterpriseEdition |
| | (J2EE) platform. The Java-based application and |
| | transaction infrastructure delivers high-volume |
| | transaction processing for e-business and provides |
| | enhanced capabilities for transaction management, |
| | as well as security, performance, availability, |
| | connectivity, and scalability. IBM ™ WebSphere |
| | Product Pages^{xxiv} |

### Further Embodiments

It will be understood that the embodiments of the present invention described herein are by way of example only, and that various changes and modifications may be made without departing from the scope of invention.

It will be understood that any reference to displaying a visual representation on a screen equally applies to storing that representation or printing the representation onto any suitable medium. As explained above, the data used to display, store or print may be adjusted by the system according to the purpose of the data.

Further, it will be understood that any references in this document to any modules, engines or associated processing, analysis, determination, or other steps, may be implemented in any form. For example, the modules or engines may be implemented, and the associated steps may be carried out, using hardware, firmware or software.

Further, it will be understood that a genetic algorithm may be employed to breed an optimized solution passing through discrete data points (or minimizing variance). The optimized surface may have prescribed characteristics, such as local dimples or peaks near discrete data values.

Further, it will be understood that the data storage modules described herein may be any suitable type of data storage system. For example, they may be an enterprise data warehouse (EDW), a data mart, a database, a storage array or any other suitable device or groups of devices that can store data for later retrieval. Further, the data storage module may be a cache memory used to temporarily store incoming data captured in real time.

Further, it will be understood that the input data provided to the systems described herein may be of any suitable type of data, for example, real world data including, but not limited to, gaming or gambling data associated with a gaming environment such as a casino, event data, test or quality control data obtained from a manufacturing environment, business data retrieved from an accounting system, sales data retrieved from a company database, etc. All this data may be received by the system in real time in a cache memory or may be stored in a more permanent manner.

Further, it will be understood that, as an alternative to, or in conjunction with, the display module, further output modules may be provided to output the results of the rendering module. That is, the raw data retrieved by the data retrieval module is analyzed and converted to provide output data in a specific format. The output data is provided to the display and/or further output modules to enable a user to visualize the raw data in a manner that conveys more useful or hidden information that would otherwise be lost.

Further, it will be understood that, the further output module may be a printing device in communication with the described system to receive print control data so that representations of the data may be printed on any suitable print medium. Alternatively, the further output module may be an interface that enables the data output from the various modules to be interfaced with other data handling modules or storage devices.

Further, it will be understood that the interpolation function may be a gravity function, and that the gravity function may be an inverse function, an inverse square function or a variogram model.

Further, it will be understood that the interpolation function may be a statistical function, where the surface is obtained from kriging. Further, the kriging may minimize the variance of an estimate whilst maintaining a desired surface characteristic. For example, the surface characteristic may be smoothness, or a linear combination of data points.

Further, it will be understood that the interpolation function may be a genetic algorithm.

Further, it will be understood that the interpolation function may be a distribution function which is a weighted average of several applications of an inverse distance weighting method using different distance functions. For example, the weights may sum to s, where s is greater than zero.

Further, it will be understood that the first interpolation may be a general smoothing function. For example, the first interpolation function may be a weighting function. Also, the surface generated by the first interpolation function may be below or equal to every discrete data point. Also, a secondary smoothing function may be applied to minimize differences between the surface generated by the first interpolation function and the discrete data points. Also, a further interpolation function may be applied so that the resulting surface passes through or near every discrete data point. Further, the further interpolation function may generate a surface having a steep gradient near discrete data points. Further, the further interpolation function may generate a surface that has dimples at or near minima and peaks at or near maxima

With regards to one or more of the above described embodiments, references are made to the following papers:
Franke R, Nielson G. Smooth Interpolation of Large Sets of Scattered Data (1980). International Journal for Numerical Methods in Engineering, 15(2):1691.
Isaaks, E. H. and Srivastava, R. M. (1989). An Introduction to Applied Geostatistics. Oxford University Press, New York.
Yang Ch, Kao S., Lee F., Hung P. 2004. Twelve Different Interpolation methods: A Case Study of Surfer 8.0. Geo-Imagery Bridging Continents, XXth ISPRS Congress, 12-23 Jul. 2004 Istanbul, Turkey. http://www.isprs.org/istanbul2004/comm2/papers/231.pdf
Landasse, A., Lee, J., E. de Bodt, Wertz, V., and Verleysen (2003). Approximation by Radial Basis Function Networks.
Johnson, Richard A. Wichern, Dean W. (2002). Applied Multivariate Statistical Analysis, Prentice Hall, Upper Saddle River, N. J.
Wang, J. G. and Liu, G. R. (2002). A point interpolation meshless method based on radial basis functions. International Journal for Numerical Methods in Engineering, 54:1623-1648.
ⁱWikipedia; “Heat map”; Date Accessed, Jun. 10, 2008; http://en.wikipedia.org/wiki/Heat_map
ⁱⁱNasdaq; Nasdaq-100 Dynamic Heatmap; Date Accessed, Jun. 10, 2008; http://screening.nasdaq.com/heatmaps/heatmap_{—}100. asp
ⁱⁱⁱWeather.com; Date Accessed, Jan. 31, 2008; http://weather.com/.
^{iv}Information Aesthetics; Information Aesthetics; “travel time maps”; Date Accessed, Jan. 31, 2008; http://infosthetics.com/archives/locative/
^{v}Few, Stephen—from white paper “BizViz: The Power of Visual Business Intelligence”—Mar. 7, 2006. www.perceptualedge.com
^{vi}Wikipedia; Wikipedia; “Voronoi Diagram”; Date Accessed, Jan. 31, 2008; http://en.wikipedia.org/wiki/Voronoi_diagram.
^{vii}ENTROPÍA; ENTROPÍA; “Más tiempo”; Date Accessed, Jan. 31, 2008; http://www.luispabon.com/entropia/index.php?entry=entry071129-145959.
^{viii}Wikipedia; Wikipedia; “Agile Software Development”; Date Accessed, Jan. 30, 2008; http://en.wikipedia.org/wiki/Agile_software_development
^{ix}Wikipedia; Wikipedia: “Dimensional Modeling”; Date Accessed: Apr. 10, 2008; http://en.wikipedia.org/wiki/Dimensional_modeling
^{x}Kimball, Ralph, A Dimensional Modeling Manifesto; Date Accessed: Apr. 10, 2008; http://www.dbmsmag.com/9708d15.html
^{xi}Sam's Publishing; developer.com Gamelan™; “Introduction to EJB's”; http://www.developer.com/java/ejb/article.php/1434371.
^{xii}Wikipedia; Wikipedia: “Dimensional Modeling”; Date Accessed: Apr. 10, 2008; http://en.wikipedia.org/wiki/Dimensional_modeling
^{xiii}Gilbert, Cheryl, et. al.; SearchCIO—Midmarket; “IIOP”; date Accessed, Jan. 30, 2008; http://searchcio-midmarket.techtarget.com/sDefinition/0,,sid183_gci214019,00.html.
^{xiv}Google; Google Maps; “KML Gallery: Explore the Earth on Google”; Date Accessed, Jan. 30, 2008; http://earth.google.com/gallery/
^{xv}Wikipedia; Wikipedia; “Mean down time”; Date Accessed, Jan. 30, 2008; http://en.wikipedia.org/wiki/Mean_down_time.
^{xvi}Wikipedia; Wikipedia; “Mean time between failures”; Date Accessed, Jan. 30, 2008; http://en.wikipedia.org/wiki/Mean_time_between_failures.
^{xvii}Wikipedia; Wikipedia; “Mean time to recovery”; Date Accessed, Jan. 30, 2008; http://en.wikipedia.org/wiki/Mean_time_to_recovery.
^{xviii}Paris Technologies, Inc.; Paris Technologies; “OLAP”; Date Accessed, Jan. 30, 2008; http://www.olap.com.
^{xix}Wikipedia; Wikipedia; “Planogram”; Date Accessed, Jan. 30, 2008; http://en.wikipedia.org/wiki/Planogram.
^{xx}Wikipedia; Wikipedia; “Software as a Service”; Date Accessed, Jan. 30, 2008; http://en.wikipedia.org/wiki/Software_as_a_Service.
^{xxi}Wikipedia; Wikipedia; “Self-organizing map”; Date Accessed, Jan. 30, 2008; http://en.wikipedia.org/wiki/Self-organizing_map.
^{xxii}Zeiger, Stefan, Servlet Essentials, Version 1.3.6—Nov. 4, 1999; Date Accessed, Jan. 30, 2008
^{xxiii}Six Sigma; Subject Matter Expert—SME; Date Accessed: Jan. 30, 2008; http://www.isixsigma.com/dictionary/Subject_Matter_Expert_-_SME-396.htm
^{xxiv}IBM; WebSphere Product Pages; “WebSphere software”; Date Accessed: Jan. 30, 2008; http://www-306.ibm.com/software/websphere/?pgel=ibmhzn&cm_re=masthead-_-products-_-sw-websphere.

What we claim is:

1. In a data visualization system, a method of graphically representing discrete data as a continuous surface in image space, the method comprising the steps of:
a data retrieval module retrieving discrete data from a data storage device in communication with the data visualization system;
an interpolation module calculating a first set of values for a weighted interpolation function based on the retrieved discrete data;
a smoothing module calculating a second set of values for one or more weighted approximation functions based on the retrieved discrete data; and
a surface combining module combining the first and second set of calculated values over the image space to graphically represent a continuous surface.

2. In a data visualization system, a method of graphically representing discrete data as a continuous surface in image space, the method comprising the steps of:
a data retrieval module retrieving discrete data from a data storage device in communication with the data visualization system;
an interpolation module calculating values for different weighted interpolation functions across the image space based on the discrete data; and
a surface combining module combining the values of the different weighted interpolation functions over the image space to develop a continuous surface.

3. A method as claimed in claim 1 or claim 2 wherein the interpolation function is a gravity function.

4. A method as claimed in claim 3 wherein the gravity function is an inverse function.

5. A method as claimed in claim 3 wherein the gravity function is an inverse square function.

6. A method as claimed in claim 3 wherein the gravity function is a variogram model.

7. A method as claimed in claim 1 or claim 2 wherein the interpolation function is a statistical function.

8. A method as claimed in claim 7 wherein the surface is obtained from kriging.

9. A method as claimed in claim 8 wherein kriging minimizes variance of an estimate whilst maintaining a desired surface characteristic.

10. A method as claimed in claim 9 wherein the surface characteristic is smoothness.

11. A method as claimed in claim 9 wherein the surface characteristic is a linear combination of data points.

12. A method as claimed in claim 1 or claim 2 wherein the interpolation function is a genetic algorithm.

13. A method as claimed in claim 1 or claim 2 wherein the interpolation function is a distribution function which is a weighted average of several applications of an inverse distance weighting method using different distance functions.

14. A method as claimed in claim 12 wherein the weights sum to s, where s is greater than zero.

15. A method as claimed in claim 1 or claim 2 wherein a first interpolation is a general smoothing function.

16. A method as claimed in claim 15 wherein the first interpolation function is a weighting function.

17. A method as claimed in claim 15 wherein the surface generated by the first interpolation function is below or equal to every discrete data point.

18. A method as claimed in claim 15 wherein a secondary smoothing function is applied to minimize differences between the surface generated by the first interpolation function and the discrete data points.

19. A method as claimed in claim 15 wherein a further interpolation function is applied so that the resulting surface passes through or near every discrete data point.

20. A method as claimed in claim 19 wherein the further interpolation function generates a surface having a steep gradient near discrete data points.

21. A method as claimed in claim 20 wherein the further interpolation function generates a surface having dimples at or near minima and peaks at or near maxima.

22. In a data visualization system, a method of graphically representing discrete data as a continuous surface in image space comprising the steps of:
a data retrieval module retrieving discrete data from a data storage device in communication with the data visualization system;
a smoothing module calculating a smoothed interpolated surface for the discrete data;
an interpolation module calculating a high order interpolation for the discrete data; and
a surface combining module combining the smoothed interpolated surface with the high order interpolation to adjust source points for the discrete data so the source points pass through the source.

23. The method of claim 22 wherein the source points are adjusted to pass through the source by creating a local maxima and minima.

24. In a data visualization system, a method of graphically representing discrete data as a continuous surface in image space comprising the steps of:
a data retrieval module retrieving discrete data from a data storage device in communication with the data visualization system;
a smoothing module generating a continuous surface using a cumulative function utilizing a first distance function; and
an interpolation module applying a second distance function to the continuous surface, where the second distance function is greater than the first distance function.

25. The method of claim 24, wherein the cumulative function includes the sum of the points surrounding the discrete data divided by the first distance function.

26. In a data visualization system, a method of graphically representing discrete data as a continuous surface in image space comprising the steps of:
a) a data retrieval module retrieving discrete data from a data storage device in communication with the data visualization system;
b) a smoothing module calculating a primary smoothed interpolated surface for the discrete data;
c) the smoothing module calculating a secondary smoothed interpolated surface from the results of step b);
d) a weighting module applying a weighting function to the results of step c); and
e) an interpolation module applying an interpolation surface to the results of step d).

27. The method of claim 26, wherein step f) includes the steps of the interpolation module calculating residuals based on the difference between the smoothed surface in step e) and the discrete data, and applying the interpolation surface based on the residuals.

28. The method of claim 26 further including the step of:
b2) the weighting module applying a weighting function to the results of step b) where step c) calculates the secondary smoothed interpolated surface from the results of step b2)

29. In a data visualization system, a method of graphically representing discrete data as a continuous surface in an image space comprising the steps of: an interpolation module building a cumulative sequence of gravity models with increasing Power (P) values, wherein the final surface passes exactly thru the source points and the P values for the sequence of gravity models are increasing.

30. A data visualization system for graphically representing discrete data as a continuous surface in image space, the system comprising:
a data retrieval module adapted to retrieve discrete data from a data storage device in communication with the data visualization system;
an interpolation module adapted to calculate a first set of values for a weighted interpolation function based on the retrieved discrete data;
a smoothing module adapted to calculate a second set of values for one or more weighted approximation functions based on the retrieved discrete data; and
a surface combining module adapted to combine the first and second set of calculated values over the image space to graphically represent a continuous surface.

31. A data visualization system for graphically representing discrete data as a continuous surface in image space, the system comprising:
a data retrieval module adapted to retrieve discrete data from a data storage device in communication with the data visualization system;
an interpolation module adapted to calculate values for different weighted interpolation functions across the image space based on the discrete data; and
a surface combining module adapted to combine the values of the different weighted interpolation functions over the image space to develop a continuous surface.

32. A data visualization system for graphically representing discrete data as a continuous surface in image space, the system comprising:
a data retrieval module adapted to retrieve discrete data from a data storage device in communication with the data visualization system;
a smoothing module adapted to calculate a smoothed interpolated surface for the discrete data;
an interpolation module adapted to calculate a high order interpolation for the discrete data; and
a surface combining module adapted to combine the smoothed interpolated surface with the high order interpolation to adjust source points for the discrete data so the source points pass through the source.

33. A data visualization system for graphically representing discrete data as a continuous surface in image space, the system comprising:
a data retrieval module adapted to retrieve discrete data from a data storage device in communication with the data visualization system;
a smoothing module adapted to generate a continuous surface using a cumulative function utilizing a first distance function; and
an interpolation module adapted to apply a second distance function to the continuous surface, where the second distance function is greater than the first distance function.

34. A data visualization system for graphically representing discrete data as a continuous surface in image space, the system comprising:
a data retrieval module adapted to retrieve discrete data from a data storage device in communication with the data visualization system;
a smoothing module adapted to calculate a primary smoothed interpolated surface for the discrete data, and calculate a secondary smoothed interpolated surface from the primary smoothed interpolated surface;
a weighting module adapted to apply a weighting function to the secondary smoothed interpolated surface and
an interpolation module adapted to apply an interpolation surface to the output from the weighting module.

35. A data visualization system for graphically representing discrete data as a continuous surface in an image space, the system comprising an interpolation module adapted to build a cumulative sequence of gravity models with increasing Power (P) values to produce a final surface, wherein the interpolation module is adapted to pass the final surface exactly thru the source points and apply increasing P values for the sequence of gravity models.
